(19) United States
(12) Patent Application Publication
(10) Pub. No.: US 2006/0184977 A1
(43) Pub. Date: Aug. 17, 2006

(54) Method and apparatus for broadcast communications

(76) Inventors: Daniel Mueller, London (GB); Francis Cretney, London (GB)

Correspondence Address: Eric M Gayan;Standley Law Group, Suite 210, 495 Metro Place South, Dublin, OH, 43017-5319, US

(21) Appl. No.: 10/550,180

(22) PCT Filed: Mar. 22, 2004
(86) PCT No.: PCT/GB04/01231

§ 371 Date: Sep. 21, 2005

(30) Foreign Application Priority Data
Mar. 21, 2003 (GB) 0306603.2

(51) Int. Cl. H04N 7/173; G06F 13/00; G06F 3/00; H04N 5/445

(52) U.S. Cl. 725/86; 725/87; 725/61

(57) ABSTRACT

An interactive broadcasting system is arranged to receive and respond to user inputs in relation to broadcast material. A scheduler (1200) polls continuously for new user inputs and adjusts its scheduling appropriately, in accordance with algorithms. This might be for example to insert content from user inputs into a live or pre-recorded broadcast or to re-order elements of a broadcast, such as travel clips from a playlist. The system has many applications. Users can for example post messages or dedications, interact in discussion programmes, vote for clips from a playlist, request live feeds, enter competitions or make purchases. Optionally, the response of the scheduler (1200) can be time dependent, for instance changing algorithms or scheduled content at a particular time of day or day of the week. As well as the scheduler (1200), embodiments of the invention provide a broadcast assembly system for storing broadcast elements, processing user inputs and assembling broadcast elements in accordance with processed user inputs for broadcast communications. Embodiments of the present invention are not limited to dealing with single broadcast channels but can also be used to playout multiple interactive channels. Such multiple channels can share either content or user interactivity or each channel may be entirely different in what is broadcast.

The present invention relates to methods and apparatus for use in broadcast communications. For instance, embodiments of the present invention relate to scheduling and/or assembling broadcast material.

Broadcasting in communications is the ability to transmit content from one source to more than one delivery point, usually user apparatus such as a radio, television, PDA or personal computer (“PC”), during the same time period. As used in this specification, “broadcasting” includes for example multicasting in which content can be delivered to a group of two or more delivery points during the same time period, the group being selected from a larger population of possible delivery points. It can be the same content going to each delivery point or a different content going to each delivery point as required.

In broadcasting, content may be transmitted from one or more broadcast centres in the form of scheduled programmes. To receive a programme, a user selects a programme channel. Delivery of the programme to the delivery point can nowadays be done in several different ways and might use for example one or more of television, radio, the Internet, mobile telecommunications, local communication centres and/or other media.

Broadcasting tends to present a high entry cost to new broadcasters entering the market. The broadcast centres rely on bespoke system architectures that are expensive to build and maintain, being specially designed and built for the individual broadcaster or service provider. New companies who want to launch new channels must raise significant capital sums to build, lease or outsource expensive broadcast facilities before they can start broadcasting and generating revenue. This high entry cost therefore limits competition in the broadcast market.

Broadcasting also tends to be inflexible. Television and radio channels usually prepare their detailed programme schedules, what they will broadcast and when, at least three weeks in advance. These schedules are then made available via newspapers, magazines and electronic programme guides (EPGs). If a user wants to receive a particular

programme he/she has to arrange their day around the broadcast schedule or remember to preset their video/audio recorder.

Further, the flow of information in typical broadcast environments is one way. The broadcaster broadcasts the content to users. Any feedback from users is derived for instance from ratings data. This data is based on a statistically significant but generally small sample of users using either a hand written or electronic diary. The diaried ratings data is then collected and processed by the broadcaster for use in future programming decisions.

Up until recently, television channels have been tape based and have simply provided “linear playout” in which programmes are broadcast according to a predetermined schedule. As the costs of mass storage came down and the quality of encoding methods improved, systems started to migrate from tape based to disk based systems. These systems were still expensive and for linear playback only.

As technology has further improved it has become possible to build PC based systems for disk-based playout. These have been used for example for transmitting videos to users. Currently in the video playout market there are generally two kinds of PC based playback systems. The first is for linear playback, equivalent to the earlier broadcasting systems. The second is slightly more flexible. This is interactive video in which selected video material can be requested by a user, for instance using a telephone-based Interactive Voice Response (“IVR”) menu. However, interactive video systems are still expensive to provide and offer very limited interactivity. They can also be complicated to use.

Although not broadcasting in the manner of traditional television, interactive video, “video on demand” and the like can be considered a form of broadcasting since content is in practice available to more than one delivery point from the same source during the same time period. Either the same or different content may be available from the source to each delivery point.

According to a first aspect of the present invention, there is provided a scheduling system comprising:
i) a scheduler for scheduling broadcast elements for broadcasting; and
ii) a user input data store for storing user input data
   in which the scheduler is adapted to access the user input data store and to schedule broadcast elements, the scheduling of one or more broadcast elements being at least partially determined by stored user input data.

The stored user input data might comprise one or more user inputs themselves and/or data about the user inputs such as numbers of inputs received. For instance, the stored user input data might comprise one or more of the following, depending on the nature of the interactive service being supplied at the time: votes or counted numbers of votes, requests for information, multiple choice selections such as answers to questions asked of viewers, competition entries, purchasing information, and content for broadcasting such as clips, text messages, picture messages and dedications. The data can take various forms, including but not limited to numbers, text, graphics, pictures, audio and video, or any combinations of those.

The broadcast elements comprise material which will actually be broadcast, either alone or together with other broadcast elements, and may be long or short. For example, a broadcast element may be a short part of a programme, such as an introduction or closing passage, a video or audio clip, or it might fill a programme break such as an advertisement. Alternatively it could be part of a day or week's broadcasting, or part of a channel. A broadcast element may also be material which is to be shown at the same time as other material in a broadcast. For example, in a screen-based system it might be a piece of text or artwork shown as an overlay, or a voiceover.

A scheduling system according to an embodiment of the invention might further comprise an asset store for storing broadcast elements to be scheduled by the scheduler. These broadcast elements might be assembled for storage from one or more of several sources. For example, stored broadcast elements might comprise video and/or audio clips assembled from tape or disc, text or graphic overlays and prerecorded presentation material such as run-ins, introductory and closing material.

Preferably, the asset store is adapted to store as “assets” scheduling criteria as well as broadcast elements. Scheduling criteria may comprise data and/or logic such as rules, algorithms and playlists for use in determining how the scheduler deals with broadcast elements of different types and/or at different times.

A user input might itself comprise one or more broadcast elements, such as a message or dedication to appear on-screen. Alternatively or additionally, a user input or stored user input data might simply identify one or more broadcast elements. For instance, the stored user input data might comprise one or more votes or requests for broadcast elements, such as items from a playlist.

Broadcast elements identified by stored user input data might be internal to the broadcasting system, for instance stored in the broadcast element store, or at least one or more might be external to the broadcasting system. Broadcast elements external to the system might be accessible by the broadcasting system but not stored or otherwise controlled by it. For example, an element that might be identified might be a live news feed provided by an independent broadcasting service.

Broadcast elements might be identified directly, for example by codes allocated to individual broadcast elements, or they might be identified indirectly, for example by a channel and perhaps time of day information.

It is not essential that the scheduler is adapted to access the user input data store directly. It might in practice receive user input data via another device or other devices, or via other software.

The broadcasting system may further comprise a user input processor for processing user inputs. This might be adapted to process user inputs so as to produce user input data for storage in the user input data store, or to process user input data which has already been stored in the user input data store. The processing done by the user input processor might take any one or more of various forms. For instance, the processor might sort user inputs according to type so that they can for instance be stored according to type. Alternatively or additionally, the processor might be used to read, or at least recognise, content in the user inputs, for example to read and count votes or requests, or to read and assess competition entries or answers to questions. The processor might be adapted to recognise broadcast elements comprised by a user input. Preferably, the processor is adapted to provide a validating and/or editing facility for broadcast elements comprised by user inputs.

Preferably, the user input processor is connected to deliver processed user inputs for storage in the user input data store for use by the scheduler in scheduling broadcast elements. The scheduling of one or more broadcast elements may then be at least partially determined by processed user input data. For example, where the processor sorts user inputs according to type, the scheduler might schedule different types differently, such as scheduling dedications so that they overlay a relevant clip but scheduling messages to appear on receipt without waiting for a specific clip.

Where the processor is used to read content in the user inputs, the scheduling of one or more broadcast elements may be at least partially determined by that content. For instance, where the processor is used to count user input data such as votes or requests, the scheduling of one or more broadcast elements may be at least partially determined by the result of the counting, for example the number of votes or requests received in respect of individual broadcast elements. Where the processor is used to assess user input data such as competition entries or answers to questions, the scheduling of one or more broadcast elements may be at least partially determined by the result of the assessment, for example by scheduling a winning competition entry or correct answer to a question as a broadcast element. Alternatively, a broadcast element for scheduling might be constructed by processing user input data, for instance by tabulation of user responses to a multiple choice question.

One way in which scheduling might be determined is by setting a priority or frequency with which a broadcast element is repeated. This would be particularly appropriate for instance where the processor is used to count user input data such as votes or requests for broadcast elements such as items from a playlist. The priority or frequency with which the items are scheduled can be determined by the number of votes or requests received in respect of the items.

Preferably, the scheduling system is provided with a first output for scheduled broadcast elements for broadcasting and a second output for processed user inputs and/or broadcast elements. The first output preferably comprising output from a scheduler of scheduled and unscheduled events according to predetermined requirements. This second output offers the opportunity for the user inputs or broadcast elements to be made available beyond a broadcast channel. For example, they could be made available via a website for access over a different and potentially much longer period, if desired.

In use, an embodiment of the present invention is preferably connected to one or more communication systems for use by users in providing inputs for storage in the user input data store. Such a communication system might be a telephone network, a local area network, the Internet or any other suitable network but preferably it can receive and transmit user inputs in a format directly suitable for storage in the user input data store. For example, a mobile telephone network can receive and transmit user inputs in the form of text messages which can be loaded directly to a user input data store. Similarly, data networks such as a local area network or the Internet can receive and transmit text messages.

In embodiments of the invention, as mentioned above a user input can itself comprise a broadcast element and this might be for instance in the form of audio, text, pictures or graphics. Thus embodiments of the invention can be designed to support on-screen (or on-air in the case of audio services) broadcasting of user generated messages. Users receiving a broadcast can interact with it in a number of ways, including but not limited to sending messages for broadcasting to other users. In this way, users can express their opinions in a broadcast for their peers to share and comment on and can also dedicate broadcast content.

Thus embodiments of the present invention can be designed to support a relatively wide range of interactivity between a user and the broadcast system creating a stronger relationship between viewer and programme, daypart or channel.

The use of a scheduler responsive substantially in real time to select and schedule programme elements is particularly advantageous. It can for example provide flexible programming in direct response to user demand. For example, if the programme being transmitted follows a playlist, the playlist can be altered in response to demand.

Preferably the system further comprises means to adjust the response of the scheduler to user inputs according to time period. The time period might be for example part of a day, in which case the behaviour of the scheduler can be altered at different times of day. However, the time period might alternatively be part of a week, in which case the behaviour of the scheduler can be altered on different days, for example at weekends.

The response of the scheduler might be adjusted in more than one way. Preferably, the scheduler is provided with at least one algorithm which at least partially determines its response. The response of the scheduler can then be adjusted by changing the algorithm, or parameters used by the algorithm, according to time period. For example, user inputs might identify specific broadcast elements. It would be possible that the scheduler treats the user inputs as votes for viewing those broadcast elements at one time of day and treats them as votes for discarding those broadcast elements at another time of day. Alternatively or additionally, the algorithm might stay the same but the response of the scheduler might be adjusted by changing the broadcast elements it schedules in response to user inputs. For example, the scheduler might schedule broadcast elements from a specified playlist in response to user inputs and that playlist might be substituted, expanded or changed according to time period.

Embodiments of the present invention can also be designed to support a wide range of different communication technologies for receiving user inputs, including not only IVR but also for example messaging (“SMS” or “MMS”), email and/or set top box formats.

According to a second aspect of the present invention, there is provided a broadcast assembly system for assembling broadcast elements for broadcast, the system comprising an asset store for storing one or more broadcast elements, and an asset processor for processing broadcast elements, wherein the asset store, in use, stores at least one rule or algorithm for use in assembling broadcast elements for broadcast and the asset processor provides at least one tool for processing broadcast elements by editing.

In the broadcast assembly system, at least one stored rule or algorithm may comprise a scheduling criterion for use in scheduling broadcast elements for broadcast. Such a scheduling criterion may comprise a rule or algorithm for responding to at least one user input. This form of the broadcast assembly system is of course particularly useful for use with embodiments of the invention in its first aspect. Alternatively, the broadcast assembly system itself may comprise a user input processor.

Preferably, at least one stored rule or algorithm is time dependent. This can allow broadcast assembly to vary, depending on time of day, day of the week, or even seasonally for example.

The broadcast assembly system might itself comprise a scheduler for assembling broadcast by scheduling, or it might be adapted for use with a separate scheduler. However, the separate scheduler would preferably be capable of applying any scheduling criteria, for instance by having a specified interface.

Preferably, the asset processor comprises means for creating or modifying one or more broadcast elements and/or rules or algorithms. This provides a very flexible and versatile system.

A broadcast system according to the second aspect of the invention might comprise:
i) an asset store for storing broadcast elements;
ii) a user input data store for storing user input data;
iii) an asset processor for processing broadcast elements; and
iv) a user input processor for processing user inputs,
   wherein the user input processor is adapted to process user input to provide user input data for storage in the user input data store and the asset processor is adapted to process broadcast elements for storage in the asset store.

As in the first aspect of the invention, the user inputs may themselves, in use, comprise one or more broadcast elements.

Embodiments of the invention in its second aspect can provide a powerful tool in the collection and processing of broadcast elements so that they can be used in subsequent scheduling, however that subsequent scheduling might be carried out. Hence this second aspect of the invention is very closely related to the first, much in the manner of a transmitter and a receiver. The second aspect of the invention can be used to assemble broadcast elements and user input data for use by the scheduler of the first aspect of the invention.

The asset store, user input data store and the user input processor according to this second aspect of the invention may each be the same as those according to the first aspect of the invention. For instance, just as in embodiments of the invention in its first aspect, the asset store may store both broadcast elements and scheduling criteria.

The asset processor might comprise any one or more of the following:
an encoder for encoding broadcast elements into a format suitable for broadcast, for instance encoding video material into MPEG format
an editor for editing broadcast elements
a programming capability for programming scheduling criteria

It should be noted that the asset processor and the user input processor might in practice be embodied within the same software application, or the functions representing the two processors might be distributed between two or more separate applications in any convenient manner. However, in general, the user input processor usually carries out its functions during broadcasting while the asset processor usually carries out its functions prior to broadcasting.

Embodiments of the invention also encompass a user input processor for use with a broadcasting system as described above, having an input for receiving user inputs, at least one processing tool for processing received user inputs, a first output for processed user inputs for use by the broadcasting system in scheduling broadcast elements and a second output for processed user inputs. The second output may be adapted for connection to the Internet. A user input processor of this type has the advantage of using processed user inputs in more than one way and to reach more than one type of user. It is not essential that user inputs are processed in the same way for both outputs.

According to a third aspect of the present invention, there is provided a method of broadcasting, said method comprising the steps of:
i) receiving a list of broadcast elements;
ii) receiving a user input relating to at least one broadcast element, and
iii) responding to the received user input.

A received user input might itself comprise at least one broadcast element in addition to those listed. Step iii) might then comprise for example broadcasting the additional broadcast element together with at least one broadcast element from the list. Alternatively or additionally, it might comprise re-ordering the list and/or outputting a reply to the user input.

The list of broadcast elements might be received for example from an asset store as mentioned above, where the asset store is adapted to store not just broadcast elements but also scheduling criteria, such as playlists.

Such a method allows a broadcasting system to overlay content from user inputs onto elements of a prescheduled programme, such as items from a sports video or music video clip list or an audio playlist.

Preferably the method further comprises the step of processing broadcast elements prior to broadcasting, for instance to encode material in a format suitable for broadcast, such as MPEG, and/or to edit broadcast elements. The ability to edit broadcast elements is particularly useful where broadcast elements can be received via user inputs and may not meet broadcast criteria.

Preferably steps ii) and iii) can be performed in a relatively short time period, for example within a day or even within an hour. More preferably, steps ii) and iii) can be performed so as to provide a substantially real time response to user inputs, for instance in ten minutes or less, or even in ten seconds or less.

Optionally, the additional broadcast element may have associated with it an identifier for a broadcast element present on the received list. This allows users to comment on, or dedicate, broadcast items such as sports video clips or music video clips.

Preferably the method further comprises the steps of:
iv) receiving at least one user input identifying at least one of the broadcast elements on the list; and
v) generating an ordered list of broadcast elements from said list, in accordance with the at least one user input.

Such a method allows a broadcasting system to respond to user input for instance by moving an item further up a playlist in response to user request.

As more channels launch on digital television platforms, each new channel will have more competition for both users and advertising and sponsorship revenue. To survive channels are likely to have to operate at as low a cost base as possible and to offer attractive services. Embodiments of the present invention can offer flexible, interactive and cost effective preparation and playout systems using a robust open architecture which is particularly suitable in this competitive environment. They can also provide a particularly flexible approach to integrating video and graphics on screen, and processes and algorithms for running both an interactive broadcast which responds substantially in real time to the user as well as a linear scheduled broadcast.

Embodiments of the present invention can also be used prior to playout, to manage a wide variety of broadcast elements from widely varied sources, including user inputs, processing them for instance by editing or validating them, and assembling them prior to scheduling together with tools for use in that scheduling, such as playlists.

Thus according to a fourth aspect of the present invention, there is provided a method of assembling broadcast elements for broadcasting, said method comprising the steps of:
i) processing at least one broadcast element and loading the processed broadcast element to an asset store;
ii) storing one or more rules or algorithms for use in assembling a set of broadcast elements for broadcast; and
ii) applying at least one of said rules or algorithms in assembling a set of broadcast elements for broadcasting, including at least one processed broadcast element.

A method according to this fourth aspect of the invention may further comprise receiving, via a user input, data relating to at least one broadcast element. The step of applying at least one of said rules or algorithms in assembling a set of broadcast elements may then be carried out in accordance with received data.

The method may further comprise receiving, via a user input, at least one broadcast element and an assembled set of broadcast elements comprises at least one broadcast element received via a user input.

Further, the method may comprise the step of broadcasting an assembled set.

Preferably, embodiments of the present invention providing playout based on one or more user inputs have a relatively quick response time. The response time seen by a user making a user input is the response time between submission of the user input and response by the system to the nature of the user input. It is preferable that embodiments of the invention have a response time between receipt of a user input by the system and response by the system to the nature of the user input of ten minutes or less. More preferably, the response time is two minutes or less. In some embodiments, the response time may be ten seconds or less.

The broadcast element is not necessarily actually broadcast within the response time. As long as the system has scheduled it, the response by the system to the nature of the user input might take different forms. For example, the system might broadcast scheduling information about the broadcast element or might transmit scheduling information in reply to the user input.

Embodiments of the present invention may make some use of existing infrastructure and technologies in order to reduce the costs of conversion. They can offer a simple way of integrating existing hardware and software components to create a comprehensive architecture, potentially with seamless redundancy.

An interactive system according to an embodiment of the invention may be used as extensively as the broadcaster requires and may be used for example to broadcast an entire channel, 24 hours per day or for parts of the day, or to broadcast just one or more selected programmes. An advantage from the broadcaster's point of view is that as a result of the interactivity inherent in embodiments of the invention broadcasters and/or advertisers can potentially obtain continuous realtime feedback from and about users. Depending on charging arrangements, it may also be possible to provide interactive broadcasting as a chargeable service and thus receive revenues from user inputs for instance by charging input calls at a premium rate.

Embodiments of the invention do not necessarily include a broadcast facility for outputting a broadcast. They can be designed to be flexible enough to be adapted to, and physically connected to, a broadcast facility. They can still provide something simple and easy to operate by users to create interactivity which has not been previously available with for example an existing or independently provided broadcast facility.

### Glossary of Terms

The following terms have the following meanings as used in this specification:
AES/EBU A digital audio transfer standard named after the Audio Engineering Society/European Broadcasting Union
CLI Calling Line Identity
DSL Digital Subscriber Line
DVI Digital Video Interactive
GPI General Programming Interface
HDD Hard disk drive of a computer.
IBS Interactive Broadcasting System
IP Internet Protocol
IVR Interactive Voice Response: a voice recognition system that interacts with callers and is usually menu-based.
Microsoft IIS Microsoft Internet Information Server MMS Multimedia Message Service, feature of 2.5 G and 3 G cell phone technology
Moderation screening user input for suitability
MPEG Moving Picture Experts Group (video file formatting)
PCI Peripheral Component Interconnect: an interconnection system between a microprocessor and attached devices in which expansion slots are spaced closely for high speed operation.
PDA Personal Digital Assistant
RAID Random Array of Inexpensive Disks, commonly comes in the following configurations.
RAID-0 has striping but no redundancy of data. It offers the best performance but no fault-tolerance.
RAID-1 provides disk mirroring and no striping. Read performance is improved since either disk can be read at the same time. Write performance is the same as for single disk storage. RAID-1 provides the best performance and the best fault-tolerance in a multi-user system.
RAID-5 includes a rotating parity array so that all read and write operations can be overlapped. RAID-5 stores parity information but not redundant data (but parity information can be used to reconstruct data). RAID-5 requires at least three and usually five disks for the array. It's best for multi-user systems in which performance is not critical or which do few write operations.
RVIS Remote User Input Server
SBS Scheduling Broadcast Server.
SDI Serial Digital Interface
SMS simple messaging or “Short Message Service”, feature of GSM cell phone technology.
SOAP Simple Object Access Protocol
SQL Structured Query Language
STB Set Top Box
SVHS Super Vertical Helix Scan
t1 line High capacity voice or data line
VBI Vertical Blanking Interval
VIS User Input Server
VOD Video on Demand
WiFi Interoperable Wireless Local Area Networks
Wi-Max WiFi with extended connectivity
XML Extensible Markup Language

Lastly, the “User Telephone Number” denotes a telephone number that the user is calling or texting from and the “User Contact Number” denotes a telephone contact number displayed to users to send (call or text) messages and requests to a channel.

An interactive broadcasting system (DBS) according to an embodiment of the present invention will now be described, by way of example only, with reference to the accompanying figures in which:

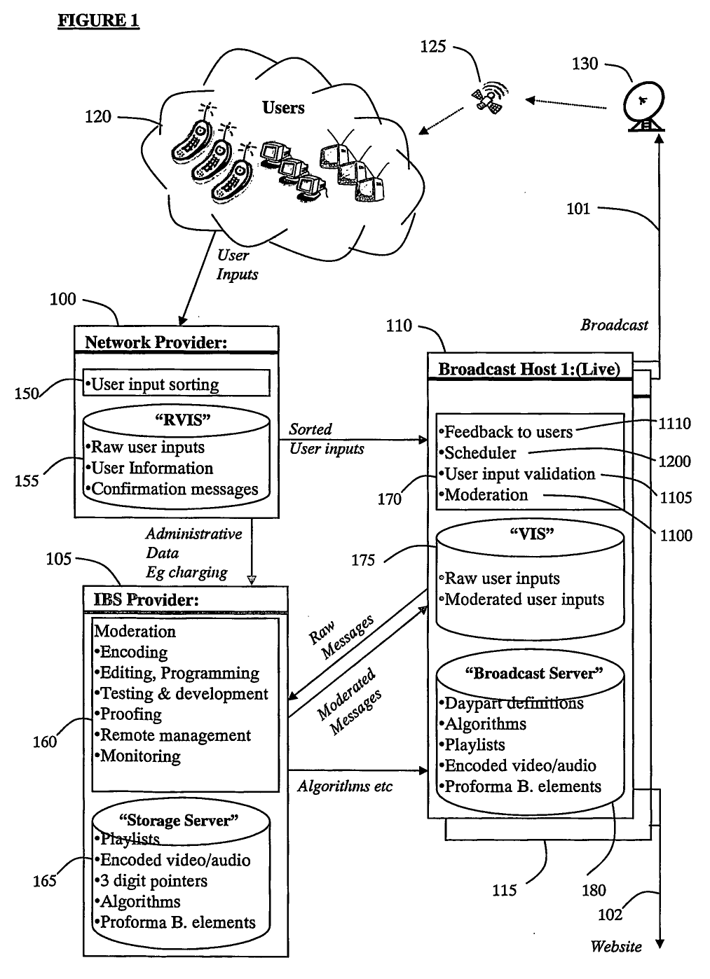

FIG. 1 shows a schematic overview of the IBS;

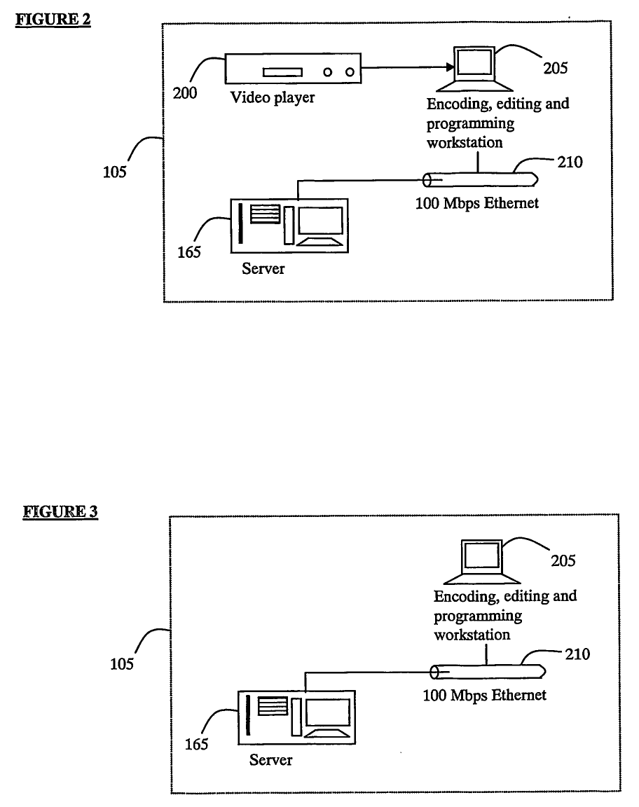

FIG. 2 shows a schematic view of a system of encoding video for use in the IBS shown in FIG. 1;

FIG. 3 shows a schematic view of a system of editing video and programming channels for use in the IBS shown in FIG. 1;

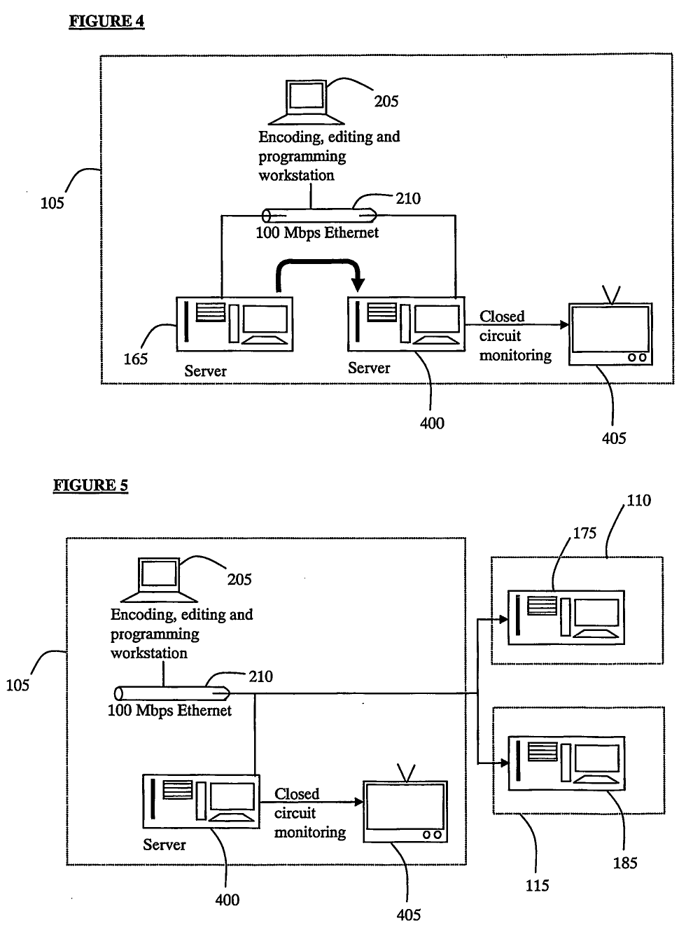

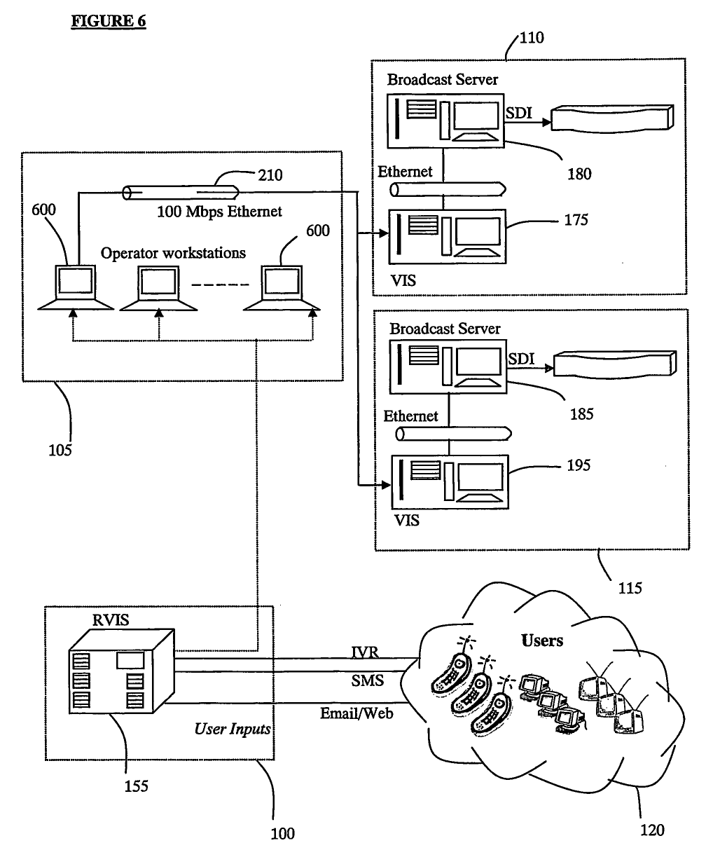

FIG. 4 shows a schematic view of a system of proofing content for use in the IBS shown in FIG. 1;

FIG. 5 shows a schematic view of a system transferring proofed content to scheduling broadcast servers for use in the IBS shown in FIG. 1;

FIG. 6 shows a schematic view of a system for moderating user inputs for use in the IBS shown in FIG. 1;

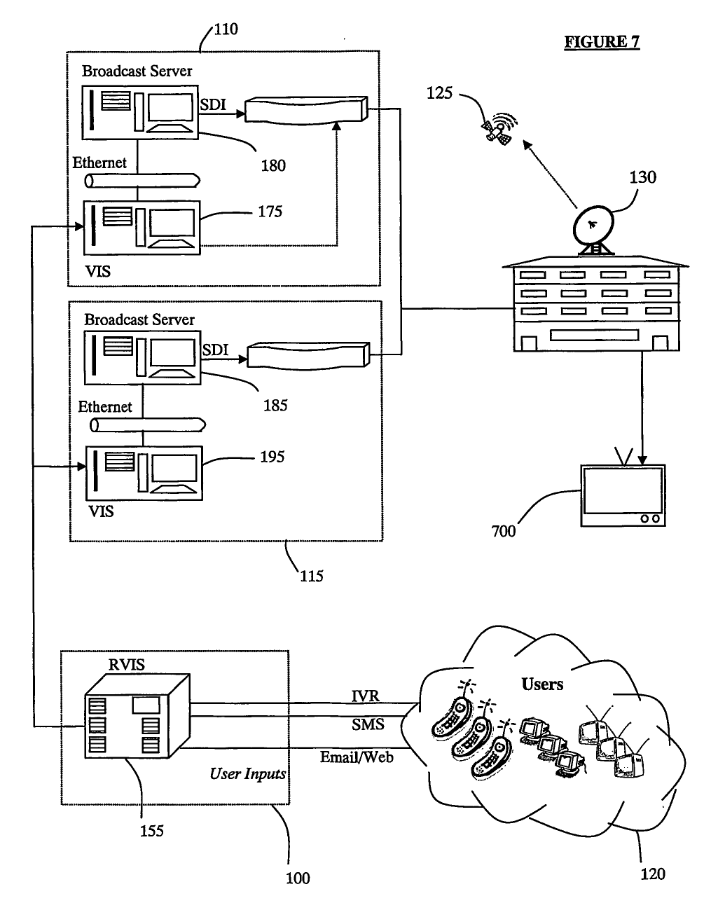

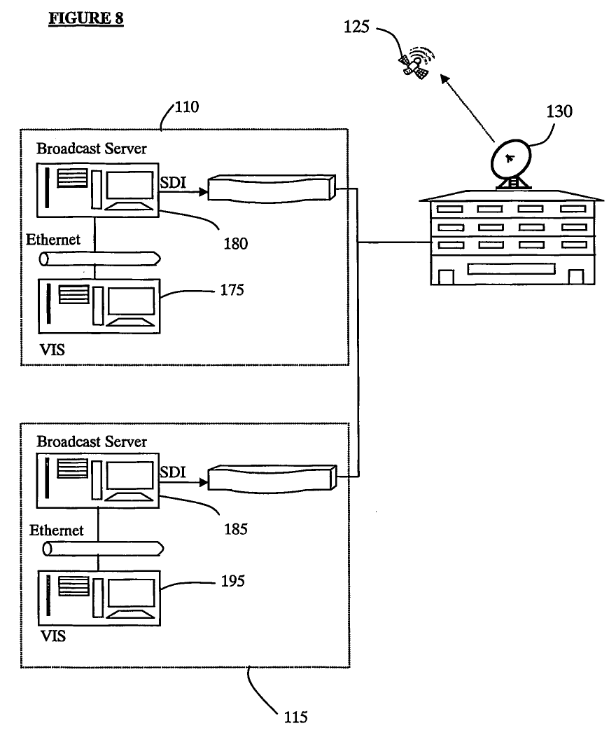

FIG. 7 shows a schematic view of a system for transferring from a live to a standby broadcast server for use in the IBS shown in FIG. 1;

FIG. 8 shows a schematic view of a system for archiving channel programming data for use in the IBS shown in FIG. 1;

FIG. 9 shows a schematic view of a system for remote management of scheduling broadcast servers for use in the IBS shown in FIG. 1;

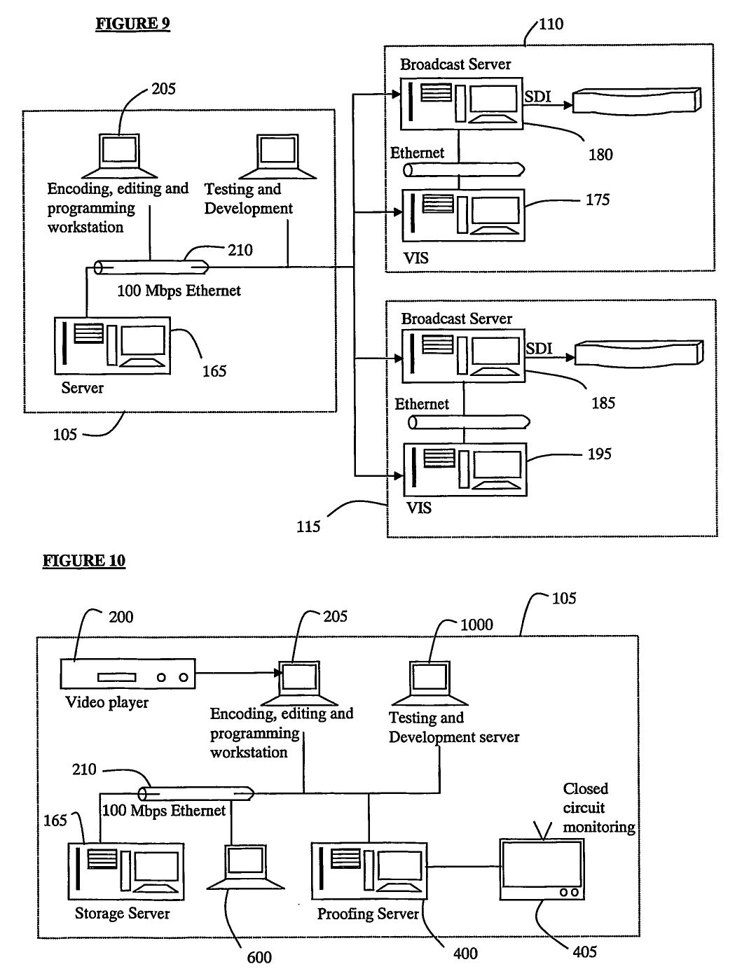

FIG. 10 shows a schematic view of a system for test and development for use in the IBS shown in FIG. 1;

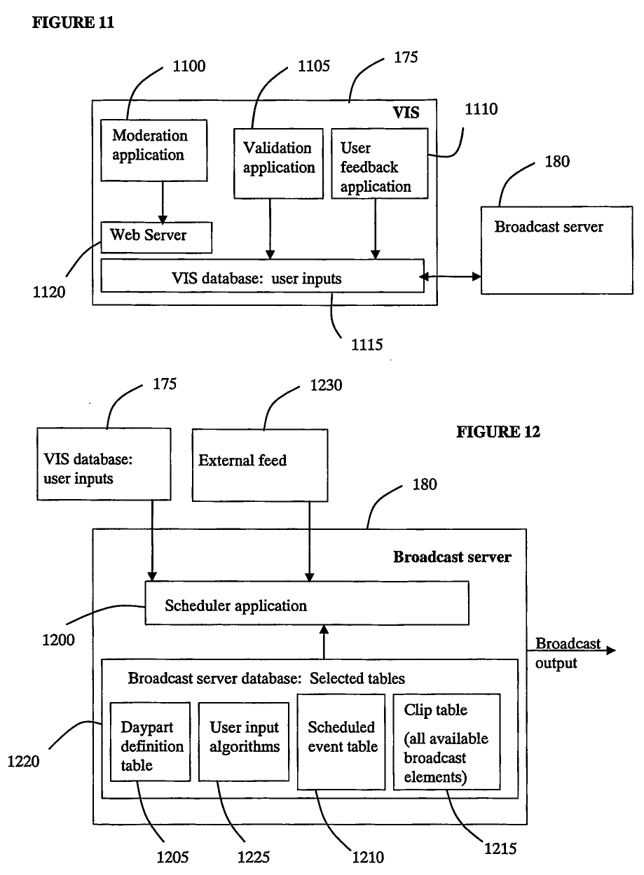

FIG. 11 shows a functional block diagram of user input processing and storage for use in the IBS shown in FIG. 1;

FIG. 12 shows a functional block diagram of equipment for assembling broadcast streams, for use in the IBS shown in FIG. 1;

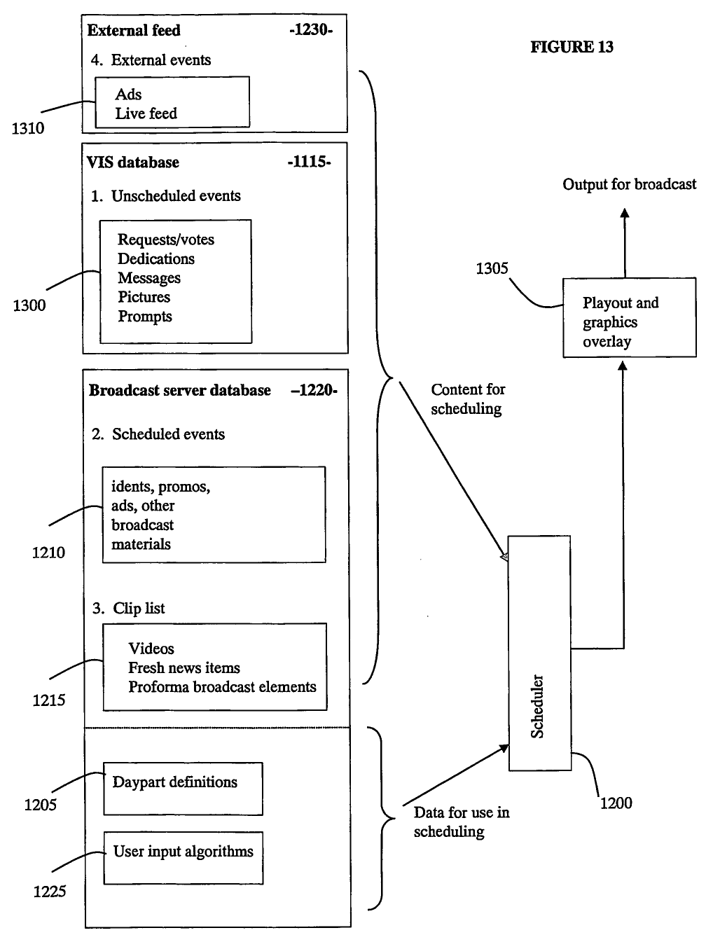

FIG. 13 shows a functional block diagram of a scheduler for use in the IBS shown in FIG. 1;

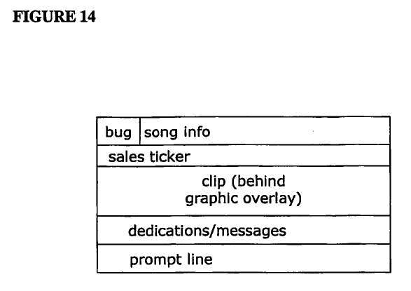

FIG. 14 shows schematically the layout of a screen showing visual material which has been broadcast by the IBS shown in FIG. 1;

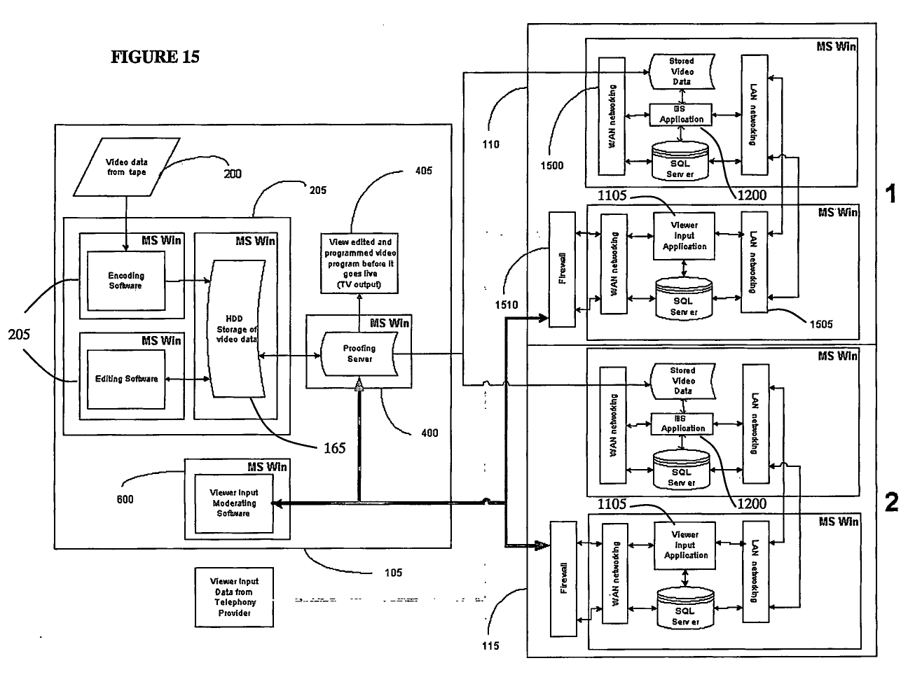

FIG. 15 shows a sample platform for supporting the IBS shown in FIG. 1; and

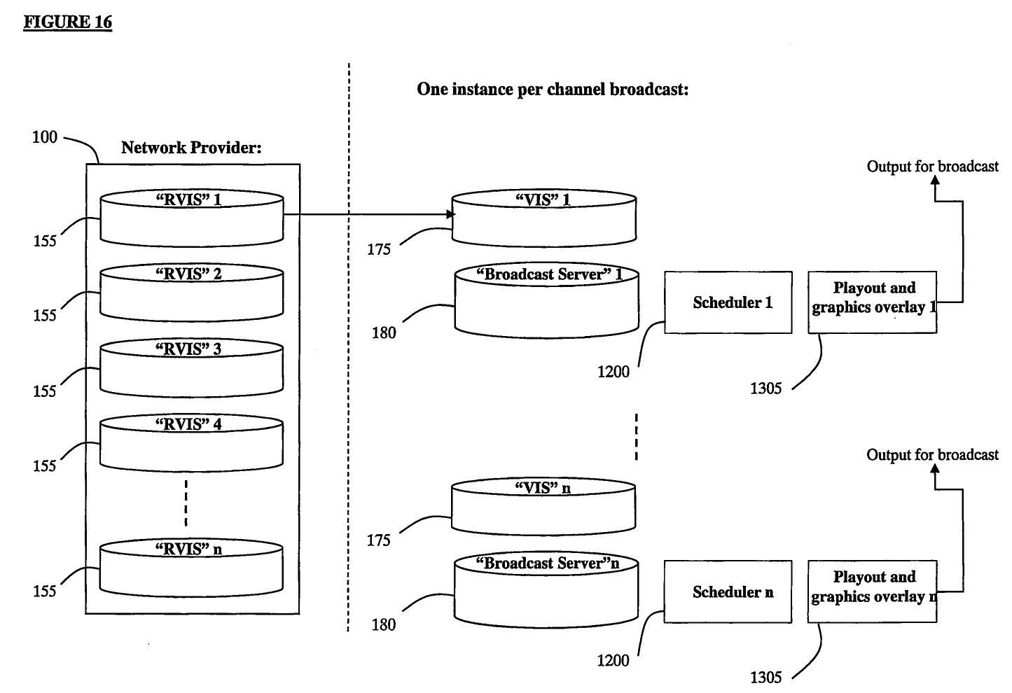

FIGS. 16 to 19 show schematic views of alternative deployments of equipment of an IBS as shown in FIG. 1 for supporting multiple channels.

### 1. IBS OVERVIEW

The interactive broadcasting system is arranged to receive and respond to user inputs in relation to broadcast material. User inputs are reviewed on receipt, parsed and written to a database. A broadcast scheduler polls continuously for new user inputs and adjusts its scheduling appropriately, in accordance with programmed algorithms. This might be for example to insert content from user inputs into a live or pre-recorded broadcast or to re-order elements of a broadcast, such as travel clips from a playlist. The system has many applications. Users can for example post messages or dedications, interact in discussion programmes, vote for clips from a playlist, request live feeds, enter competitions or make purchases. Optionally, the response of the scheduler can be time dependent, for instance changing algorithms or scheduled content at a particular time of day or day of the week. The user always receives an acknowledgement when communicating with the channel.

Referring to FIG. 1, the interactive broadcasting system (IBS) is provided primarily across three domains:
a network provider's domain 100
an IBS provider's domain 105
one or more broadcast hosting domain(s) 110, 115

The IBS broadcasts material to users 120 who can respond by making inputs to the IBS via a communications network (not shown). The user inputs are received within a network provider's domain 100 and made available to the IBS for use in modifying subsequent broadcasting. An important feature is that the IBS can give a substantially real time response so that users see the result of their inputs almost immediately. Another important feature is that content from user inputs can be shown on screen, for instance as a text overlay. This means that users can effectively communicate with each other using the screen, for instance to make dedications or to send messages.

Each of the domains 100, 105, 110, 115 provides some IBS functionality (shown in each domain on FIG. 1 within a box) and some data storage (shown in each domain on FIG. 1 within a database symbol). In the embodiment described below, each of the domains 100, 105, 110, 115 is provided with one or more servers which will support both software applications to provide the functionality and databases to provide the data storage.

It should be noted that the separation of the IBS between domains is not essential and that neither the distribution of servers, nor the distribution of functionality and data storage, is essential. In different embodiments, it may for example be possible to run the IBS in a single domain and on a single machine, such as a single server. Alternatively, any of the domains could be spread across several machines, or any two or more of the domains could share one or more of the same machines.

Although in the description below mySQL data storage is generally described, various other databases can be used, including but not limited to Microsoft Access, Oracle and SQL Server.

Broadcast transmissions reach users 120 in known manner and in this embodiment it is via an output 101 from the broadcast hosting domain(s) 110, 115 to an uplink 130 and satellite 125 although other transmission technology might be used. For redundancy, at least two broadcasting hosting domains 110, 115 are preferably used and these provide live and standby broadcast transmissions. It is however also possible to broadcast with a single hosting domain 110.

There is also a second output 102 from the broadcast hosting domain(s) 110, 115 and this goes to a website for “offline” presentation of IBS material such as selected broadcast elements and/or processed user inputs. “Offline” in this context means not part of the broadcast transmission from the first output 101.

Looking firstly at the network provider's domain 100, this provides functionality 150 for user input sorting and data storage 155 (referred to herein as the “RVIS” 155) for storing the sorted, raw user inputs. To interact with the IBS, users 120 make inputs using known communications technology, such as a telephone network (not shown). The user inputs can be of various types and these need to be sorted so that the IBS can respond to the different types appropriately. For example, a user input might be a vote for an item on a playlist, an answer to a question or a request that a message be broadcast. Again, user input sorting can be done using sorting software and known database technology. For example, the user 120 might use a first telephone number for a vote and a second telephone number for a message request. Hence votes and message requests are automatically sorted into their respective types by means of the telephone connection they are received at. Similarly all user input can be sent to a single mobile telephone short code and be sorted by the RVIS 150.

In more detail, the sorting software can sort the user input within the database based on a number of criteria, which include but are not limited to; the user input itself, the interactive service being broadcast at the time it is received, the range of valid user input, the telephone number or SMS/MMS short code the input came in on and potentially an identifier for the user who sent it. Once sorted, the user input is placed in an appropriate table in the RVIS 150. If for example the user input consists only of a three digit number and the interactive service being broadcast is a voting service, then the user input will be deemed a vote.

The sorted, raw user inputs are stored in the RVIS 155 in the network provider's domain 100. They can be delivered from there to one or more appropriate location(s) in the IBS. In this embodiment of the invention, user inputs are delivered to a server 175 (referred to herein as the “VIS” 175) in each of the broadcast hosting domains 110, 115, both live and standby. Requests and votes can be used for scheduling at the broadcast hosting domains 110, 115. However, message requests are reviewed using moderation equipment in the IBS provider's domain 105 where for example the content can be screened. Moderated message requests are then also stored in the VIS 175 in each of the broadcast hosting domains 110, 115 and used in scheduling.

Looking secondly at the IBS provider's domain 105, this provides a major part of the functionality 160 for managing the IBS, preparing broadcast content for scheduling and programming the criteria (rules/algorithms/dayparts) used in scheduling. It also provides data storage, referred to herein as the “Storage Server” 165, to support this functionality. In broad terms, the IBS provider's domain provides IBS management overall, plus an “asset manager” comprising an asset store and an asset processor. “Assets” in this context are firstly broadcast elements, however sourced, and secondly the scheduling criteria. The asset processor provides one or more tools for assembling broadcast elements and scheduling criteria, such as encoding, editing and programming tools.

In particular, the functionality provided in the IBS provider's domain 105 includes:
encoding material for broadcast
broadcast programming
proofing content and promotion to live
remote management of functionality and associated data in the broadcast hosting domains 110, 115
monitoring, and moderating user messages
format development

Looking thirdly at the broadcast hosting domains 110, 115, each of these provides functionality 170 including a scheduler 1200, for scheduling broadcast material which shows a real-time response to user inputs received at the network provider's domain 100. The scheduler 1200 can make programming decisions at the moment of broadcast, based on rules or algorithms that weight a number of factors including for example:
user inputs
playlist contents
time of day
previously broadcast material

In overview, the IBS as described below has the following aspects in use:
broadcast asset management
connectivity for receiving user inputs
user input processing
responsive scheduling of broadcast elements
broadcasting the broadcast elements
   together with tools for selecting and amending its behaviour. It can be described as comprising a broadcast asset manager, user input processor and a scheduler, where the asset manager stores and prepares the broadcast elements and scheduling criteria and the user input processor can provide any one or more of several processes such as sorting, parsing, displaying for review, counting, validating and/or forwarding of user inputs. It should be noted that these user input processes are not necessarily provided in one piece of software or application and they may well be present in more than one of the domains 100, 105, 110, 115 and even for example within an application which otherwise provides the scheduling.

The IBS as described above has an architecture based on a combination of hardware and software systems and a secure hosting environment at the broadcast hosting locations 110, 115 to operate the broadcast. The architecture is an open architecture with interfaces for integrating databases, telecommunications, monitoring and signal transport.

Although only one broadcasting system is shown in FIG. 1, the architecture is sufficiently flexible to support multiple interactive broadcast channels at the same time. For example, a set of channels can be supported which are different in terms of: broadcast hours, content, language, territory of broadcast, supported interactivity and distribution method.

Each of the three domains mentioned above is now described in more detail.

### 2. NETWORK PROVIDER'S DOMAIN 100

Users 120 can interact with broadcast material by sending in requests, answers to questions, requests for information, purchasing information for a product, votes and messages, the messages containing text and/or pictures. This can be done using standard communications such as telephony, SMS, Internet, a set top box, a voice recognition system or other communications systems. User inputs are received at the network provider's domain 100 where they are stored as data on the “RVIS” 155.

The network provider allocates specific telephone numbers and/or other addresses to enable users to send input. These numbers and other addresses are published, for example by broadcasting or by other means such as advertising. Such numbers/addresses allow user inputs to be sorted into types. For example, a first number or address might be allocated to requests and votes while a second number or address can be allocated to messages. Everything received at the first number or address can be stored in the RVIS 155 as a request or vote (requests and votes can be treated as the same at this stage) while everything received at the second number or address can be stored in the RVIS 155 as a message. Alternatively, a single telephone number or short code can be used for all user input and it will be sorted into types by the RVIS 150.

Ultimately, the user inputs are to be used in relation to a particular broadcasting channel. It is preferable that each channel has an RVIS 155 dedicated to it for the duration of the interactive service in relation to that channel. Preferably also, telephone numbers and/or other addresses allocated by the network provider to receive user inputs are specific to the RVIS 155 which will deal with the appropriate programme.

User inputs will have content which is formatted according to the type of input. In an example of a programme which might be broadcast interactively, there may be a playlist of music, sports, travel, adult or other video clips. Users 120 might be invited to submit requests or votes in relation to the video clips. Alternatively or additionally, users 120 might be invited to submit messages or dedications, answers to questions, requests for information, bids for products being sold, votes for a highlights programme or votes to see specific information broadcast. The content of these different types of user input in an example of an IBS service might be as follows:

1. Requests

At any time that the service is being offered, the user 120 can submit a request which identifies a clip from a playlist. The IBS response, once these have been processed, might be to change the order or frequency of the individual clips. A request is formatted to contain a code such as a number with a predefined number of digits (eg 2, 3, 4 or more) which identifies the clip.

2. Votes

The service identifies a specific time slot in which the user 120 must send an input. There may be a voting deadline after which no further votes will be accepted and after which users should be given a message to indicate that the voting period is over. A vote is formatted, like a request, to contain a code such as a number with a predefined number of digits which identifies the clip. The vote can be a positive or negative vote for a particular clip to be broadcast or in the case of a shopping service a vote to see a particular product.

3. Text and Picture Messages and Video Messages

At any time that the service is being offered, the user 120 can submit a message for broadcasting together with the content that happens to be playing at the time. A message can contain text and/or pictures. A message is formatted to contain a text string and/or a picture and/or video. (The message length may be restricted for programming, technical or editorial reasons, whether or not the message is deemed appropriate.)

4. Dedications

At any time that the service is being offered, the user 120 can submit a message for broadcasting together with a specific video clip. That is, the message will only be broadcast while the clip is being played or shown. A dedication is formatted to contain a code (as described above) which identifies the clip, plus a text string and/or a picture.

5. Answers to Questions

At any time that the service is being offered, the user 120 can submit an answer to a question, either as part of a live broadcast or as a competition. The aggregate answers to the question asked of the audience can be displayed during a live broadcast for the viewers to see or in the case of a competition, the individual winners names will be broadcast at a predetermined future time. An answer to a question can take the form of a letter (a, b . . . ) in the case multiple choice questions or words or numbers, depending on the exact question.

6. Request for Information

At any time that the service is being offered, the user 120 can submit a request for information about a product or programme. This applies for instance in the case of a shopping service, where a viewer would like more information about a specific product or a programme based service where the viewer requests more information about a programme, such as when it will be broadcast. The viewer may also subscribe to a service that reminds them when the programme will be broadcast and updates them with news about the programme and its cast. The response to the question will typically be in the form of a reply text message. It could also be in the form of an email or other communication method.

7. Requests to Purchase Products or Bids for Products being Sold

At any time that the service is being offered, the user 120 can submit a purchase request or bid for a product being sold. This may apply in the case of a sale, auction or bid based shopping service or other service for providing goods and/or sevices, where a viewer would like to place a bid for a specific product. The bid will only be accepted while the product is being sold. The response to the bid will typically be in the form of a reply text message. It could also be in the form of a phone call or other communication method.

8. Moves in a Single or Multiplayer Game

At any time that the service is being offered, the user 120 can submit a move in a game. This applies in the case of a single or multiplayer game that is being broadcast on the charmel. The move will only be accepted while the particular game is being played. The response will depend on the game being played but will typically have two parts, seeing a response on the television screen and a reply text message. It could also be in the form of a phone call or other communication method.

9. avi/wav File or Web Cam Stream

At any time that the service is being offered, the user 120 can submit a live or pre-recorded avi/wav file or web cam stream to be combined with the broadcast at the time it is sent or at a later point in time later on. (An avi/wav file or web stream is formatted to contain video information.)

Preferably the network provider will collect at least the following data for each user input:
i) the number or address the user input was received at and the client to which it is assigned;
ii) the full telephone number (“CLI”) the user input was received from, where available;
iii) the content, such as the identifying code and/or text string and/or picture;
iv) the time of day and date; and
v) the length of the call (where applicable).

In the above, requests and votes are described separately. However, they can be stored together in the RVIS 155 as long as the time of receipt is also stored. This is because it is the mode in which the IBS service is operating at the time of receipt which determines whether a user input is a request or a vote. It is not necessary that the mode is known at the network provider's domain 100. Instead, these user inputs will simply trigger a different response from the IBS service, depending on their time of receipt and the mode the service was operating in at that time of receipt. This is determined by the scheduler 1200 in the broadcast hosting domain(s) 110, 115.

In the above, user inputs are sorted into types by means of the number or address they were received at. However, an alternative method of sorting is to review the format of the content. For example, a vote or request is a three digit number, a message will be just a text string and/or a picture while a dedication contains a three digit number and a text string and/or picture. User inputs can thus be sorted into three types according to content format. If a user input does not adhere to a pre-defined message type (which has been published or otherwise made known to users 120) then it is not processed by the IBS. Regardless of how a user input arrives, for example by telephone or email, a valid input can be analysed and stored correctly in the RVIS 155.

It might be noted that the formats described above should not be regarded as an exclusive list. Other formats might be found appropriate to support other forms of service.

The sorted user inputs stored as data in the RVIS 155 are subsequently transferred to databases 175, 195 in the broadcast hosting location(s) 110, 115, both live and standby. These databases are each referred to herein as a “VIS” 175, 195. It is not essential that the data is first stored in the RVIS 155. The network provider's domain 100 might operate to send user inputs directly to the VISs 175, 195 but this can give rise to queuing problems. Alternatively, the RVIS 155 and a VIS 175/195 might be incorporated in a common system.

Sorted user inputs are stored in the RVIS 155 by inserting rows into a database on the RVIS 155. If user inputs are received in another form (eg, XML over TCP/IP), then a pre-processor located on the RVIS 155 will handle the input and convert it into database table. For instance the RVIS 155 might accept input via a TCP/IP service running on Microsoft IIS which will decompose the XML, determine what type of input has been received and insert the data into appropriate tables on the RVIS 155.

The RVIS 155 is configured to copy data in its user input tables to the VISs 175, 195 both live and standby. This is achieved using database distribution/replication to push user input as it arrives to the various VIS databases 175, 195. This exploits a default mechanism to send user input to each VIS 175, 195 asynchronously. Thus if a VIS is inaccessible, or merely suffers delays in peak traffic, the RVIS 155 win temporarily queue the user input until it is available again.

Other means can alternatively be used to transfer data between the RVIS 155 and the VISs 175, 195 such as an HTTP connection.

Since the RVIS 155 would be dealing with a number of channels, a configuration similar to the VIS 175 (described below) may be required. However, this activity is predictable and measurable and benchmarks should show an acceptable system size. Whatever the configuration, however, disks should preferably be mirrored for resilience.

Preferably, transfer of data to the VISs 175, 195 is done over a WAN network (dedicated line or VPN over Internet) and possibly through a firewall. The distribution/replication may take place remotely from the network provider's domain 100. Preferably the data transfer takes place over a dedicated line. Preferably user input data can be restored in case of system or component failure in the network provider's systems. In the event that there is a failed transfer of data from the RVIS 155 to a VIS 175/195 the process preferably is able to roll-back to the state it was in before the transfer was attempted. Preferably a transaction log is maintained to prevent loss of data. Any failure of data transfer between the network provider's domain 100 and the VISs 175, 195 should not affect the collection of user input. When the data transfer process recovers, the data collected in the meantime can be transferred along with the original transfer.

Further functions which can be provided from the network provider's domain 100 are charging, feedback and login procedures.

Charges for users 120 of the IBS service may be set independently for each service. For example, charges to the user for calling the IVR, SMS and MMS input can be set independently for the various different types of input (request, vote, text message, picture message etc) and for each separate broadcasting channel. For example, one channel may offer requests at 50 p, votes at 75 p and text messages at 99 p while another channel may offer the same at 40 p, 55 p and 75 p. Preferably the network provider's domain 100 monitors the amount charged for each interaction and passes it to an IBS database, provided for example on the storage server 165 in the IBS provider's domain 105.

User Feedback and Confirmation—preferably, user inputs are validated as acceptable inputs (so that they are not asking for a non-existent service, for example). Also preferably, users receive a confirmation message appropriate to the relevant user input, such as a recorded voice message if their input was made by voice. Preferably, any outgoing messages to the user have the capacity to include a message such as a reminder or an advertisement.

User Registration and Log-in—users may be required to register and log-in for some personalised services. The network provider's domain 100 may therefore need to interact with a user information dataset, probably a subset of data already at the site. This user information will need to accept data from two directions:
a) update information from the user
b) personalised messages from the IBS to the user.

Registration and login are not necessarily provided by the network provider's domain 100. Where user inputs are made over the Internet, for example, registration and login might more appropriately be provided by the IBS provider's domain 105.

It will be understood from the above that the network provider's domain 100 in this embodiment provides at least one of the user input processes which can collectively be regarded as a user input processor. For instance it provides sorting.

### 3. IBS PROVIDER'S DOMAIN 105

As mentioned above, this domain 105 provides a major part of the functionality 160 for managing the IBS, managing the broadcast assets (that is generally broadcast elements and tools/rules/algorithms for processing the broadcast elements, including dayparts) and preparing material for scheduling in accordance with user inputs. This is described below in six general areas, “3.1” to “3.6”.

In general, the IBS provider's domain 105 is supported by a network for transfer of data and software, for instance using Ethernet technology 210. Preferably transfer rates, both internal and external, will be at least 100 Mbps. This will allow timely transfer of files, though not reliable video streaming across the network.

3.1 Encoding Content for Scheduling

Referring to FIGS. 1 and 2, in the embodiment being described here, broadcasts transmitted by the IBS primarily comprise MPEG-2 video, MPEG-4 video or other encoded data which can be sent directly to a cable head or satellite uplink 130 and broadcast in known manner to delivery points such as televisions, mobile phones or PCs in users' homes/premises. In order to encode and store content, the IBS provider's domain 105 is equipped with a video player 200, a workstation 205 having a HDD for running software 160, and the storage server 165, and these taken together support what is referred to herein as broadcast asset management.

FIG. 2 shows one system of encoding video, namely transferring video data from digital or analogue tape run on the video player 200 to MPEG-4 file format on the HDD of a networked workstation 205. This involves:
1. Encoding video material from a video player 200 on to the local workstation HDD 205;
2. Storing encoded video and audio data files on one or more networked storage servers 165;
3. Validating the files; and
4. Transferring the validated files to DVD or other portable medium.

Transfer of data in this manner is relatively easy to do and there is standard software available such as Operating systems copy utilities, or Adobe Premiere provided by Adobe Systems Inc.

Data is transferred from DVD or tape to the networked storage servers 165 via the workstation HDD 205. A mySQL database on the storage servers 165 is updated with pointers to the new video files stored. Given the time taken to transfer video files and to manipulate them, an entry in the mySQL database should be recorded for each file when transfer starts, and a status flag updated as it completes transfer. All encoded files are stored on the storage server(s) 165 while those required for broadcast during a specific time period (day, week or month) are stored on the broadcast servers 180, 185 as well.

It is of course important to map the codes which are used in user inputs to the files which the codes identify. This mapping is held in a master clip database on the storage server(s) 165.

3.2 Broadcast Programming

Referring to FIG. 3, there is shown one system of programming a broadcast which is another aspect of broadcast asset management. Programming a broadcast comprises:
selecting and editing content to go in the broadcast (scheduled and unscheduled), including for example one or more playlists of video clips
weighting the clips making up each playlist so that individual clips will be repeated at an appropriate frequency in the absence of user inputs
selecting or writing one or more algorithms for determining the response of the IBS to user requests and/or votes.

Programming thus comprises the steps of:
1. Retrieving MPEG video material from the storage server 165 to the HDD of the workstation 205
2. Editing the video material using known editing software such as Avid Xpress (Trade Mark of Avid Technology Inc)
3. Selecting and weighting one or more playlists
4. Selecting or writing one or more algorithms for determining the response of the IBS to user inputs
5. Selecting or writing proforma broadcast elements such as tables or game presentations

In this context, editing means editing the actual clips to comply with programming issues such as time constraints or the watershed (for example sometimes two versions of a clip are required for showing before and after a particular time of day).

Video files are retrieved from the storage server 165 and edited locally on the workstation 205. A status flag in the mySQL database on the storage server 165 noting that the file has been ‘checked out’ should be set. This shows that it is being worked on as a warning against anyone else doing the same. In addition, the status flag could be set to an ‘approved’ or ‘ready for broadcast’ when editing is complete.

In addition, playlists and algorithms are created and updated within the mySQL database on the storage server 165. These, again, should have a status flag which can be set to show their stage of readiness.

A novel type of broadcast element that might be created or edited here is the proforma broadcast element. Preferably a proforma broadcast element is prepared in advance of broadcast with the intention that it may be modified or acted upon with user input or other input prior to and/or during broadcast. One of the possible applications of embodiments of the invention is to present processed user inputs in tabular form, for example the results of a competition or voting process. Alternatively, user inputs could be applied to an interactive game, creating broadcast elements which show a game format, updated during a broadcast to show the latest moves by the protagonists. Proforma broadcast elements can be created here and supplied to the broadcast hosting domain 110, 115 for update, according to an appropriate algorithm, by the scheduler 1200.

A preferred feature of embodiments of the present invention is the use of dayparts. This is a technique for changing the response of the scheduler 1200 delivering a broadcast according to the time of day. Preparation of the daypart programming is also done in the IBS provider's domain and can be incorporated in the algorithms mentioned above. Examples of possible algorithms are further discussed below.

3.3 Proofing Content and Promotion to Live

Referring to FIG. 4, there is shown one system of proofing prepared material and programming decisions in an environment nearly identical to live production. Proofing is preferably an integral part of the production chain. In order to carry out proofing, the IBS provider's domain 105 comprises a proofing server 400 and a closed circuit monitor 405.

Proofing comprises the steps of:
1. Retrieving relevant video material from the storage server 165 and loading it to the proofing server 400
2. Retrieving relevant playlists and algorithms from the storage server 165 and loading them to the proofing server 400
3. Starting a copy of the scheduler 1200 that will run at the broadcast hosting domain 110 during live transmission, on the proofing server 400
4. Viewing output on the closed-circuit monitor 405
5. Making any changes necessary
6. Approving the relevant material, playlists and algorithms for promotion to live and standby broadcast servers 180, 195 in the broadcast hosting domains 110, 115.

Proofing is a process which tests not just content but also that the playlists, algorithms and dayparts all work correctly.

The proofing server 400 may be a scalable copy of the production broadcast server 180. Multiple channels may share a proofing server 400. The resilience of the production broadcast servers 180 is less critical since all data can be reconstructed from the storage servers 165 (depending on the acceptable down time whilst recovery is performed). There may be multiple proofing servers 400 depending on the number of channels which require proofing around the same time window.

Data is preferably copied to the proofing server 400 from the storage servers 165 for checking prior to transmission. Once proofed, data may be copied to the live and standby broadcast servers 180, 185 for the channel. After this, the environment can be removed if necessary.

In one embodiment, content may be copied from the live and standby broadcast servers 180, 185 to replicate the production broadcast servers and files to help with problem diagnosis or to trial online fixes, data patches, reproduce bugs, simulate broadcasts, and test new content and functionality.

Video files and mySQL database content are copied to the proofing server 400. Files can be copied via standard Windows file copying mechanisms—these can be shared between multiple channels which may utilise the proofing server 400. The database content can be copied via a subroutine. This would then copy the contents of tables into the correct form from the mySQL database on the storage server 165 to a dedicated database for each channel on the proofing server 405. The subroutine would be preconfigured to ensure that only items which are ready were copied, as required. In fact, the subroutine could be configured to return an error status if everything wasn't marked ‘ready’.

Proofing is then carried out using the closed circuit monitor 405. Referring to FIG. 5, once the relevant material, playlists and algorithms have been approved for promotion to live and standby broadcast servers 180, 185 in the broadcast hosting domains 110, 115, the promotion can be carried out. This will be done by transferring approved video, audio and other data files from the proofing server 400 to the live and standby broadcast servers 180, 185. Transfer comprises the steps of:
1. Identifying approved (proofed) content for promotion on the proofing server 400
2. Making sure the live broadcast server 180 is ready to receive data
3. Initiating transfer to the live broadcast server 180, using for example a leased line or DVD with on-site installation
4. Verifying complete and error-free transfer
5. Once transfer to the live broadcast server 180 is complete, initiating data transfer to the standby broadcast server 185 and repeating steps 3 & 4.

Data transfer can potentially occur even whilst a broadcast server 180 is being used for broadcasting. The proofing server 400 should preferably contain at least files which need to be added to a current set on the broadcast server 180 to play the next schedules, and the storage server database 165 should preferably contain both the new schedules and those currently playing.

As described above, the broadcast servers 180, 185 are updated in the order live followed by standby. They may be updated at the same time or it may be preferred that the standby broadcast server 185 is updated first. The latter arrangement has the advantage that if a problem occurs, it can be detected on the standby broadcast server 185 and won't affect the live broadcast server 180. To minimise risk further, once files and database tables have been copied to the standby broadcast server 185, a cycle of selecting and starting to play a video should preferably be undertaken on the standby broadcast server 185 before the items are copied to the live broadcast server 180.

For each broadcast server 180, 185, new video files may be copied via Windows file copy to the broadcast server 180, 185. Then database tables, which contain static control information such as the algorithms and programme playlists (ie. all except logging tables), may be updated from channel-specific database tables on the proofing server 400, for example by using a mySQL subroutine. This resets the tables in question to be identical to those on the proofing server 400.

This illustrates why it is preferred that the proofing server 400 should contain the current schedules in addition to the new ones. Any emergency updates to the broadcast server 180 should preferably be reflected back to a database on the proofing server 400 prior to this replication.

Any queries currently under way on the broadcast server 180 will use an old copy of the tables even if a mySQL subroutine is underway. Once the query completes, the next query will use the new copy of the database tables. This can also be handled via a mySQL subroutine.

Playlists can be maintained for example by programmers, and updated as and when required, perhaps at regular intervals.

In addition to this mySQL copying, file copies may be used to add extra media files to the broadcast server 180 which are referenced in the playlists. At this stage, any that are not required on the new or current playlist can be removed (this could also be done at any point after the new playlist kicks in). The storage media, for example a disk, should contain sufficient space to accommodate the total composite file list from two playlists. (Storage media may of course need to be tested to ensure that it is possible to write new files to the disks while existing ones are playing.)

3.4 Remote Management of the Functionality 170 and Associated Data 175, 180 in the Broadcast Hosting Domains 110, 115

Referring to FIG. 9, it may be preferred that functionality and data at the broadcast hosting locations 110, 115 can be managed from the IBS provider's domain 105. For instance, preferred management functions to be carried out remotely, from the IBS provider's domain 105, might be changing playlists, programme rules, user input rules or algorithms, daypart definitions etc.

A suitable system for remote management comprises the steps of:
1. Securing log-in to a workstation at the IBS provider's domain 105
2. Finding a relevant broadcast server 180 on a remote network
3. Making required changes and adjustments to programming or the server 180
4. Repeating steps 2 & 3 for the next relevant broadcast server 180
5. Logging off the workstation.

A programming control application at the IBS provider's domain 105 can be used to interact directly with the live broadcast server 180 and/or functionality 170. (In practice the functionality 170 may be run on the broadcast server 180.) All such access will be via mySQL subroutines and/or wrapped in database stored procedures. Any changes will be copied to the standby broadcast server 185 using mySQL subroutine copying.

3.5 Monitoring, and Moderating user Inputs

The IBS provider's domain 105 also comprises (1) a monitoring section, to monitor the proper operation of the IBS and to intervene as and when it is appropriate to maintain its operation, and (2) a moderation section to moderate the text and pictures received from users. ITC and other regulations require that anything broadcast by a channel meet taste and decency requirements. Accordingly, all user data can be moderated and any inappropriate material removed prior to broadcast.

Preferably, all user input will be moderated on a 24/7 basis. Users expect to see their messages within a relatively short period of time or lose interest. Accordingly, it is desired that the system provide the appropriate response within a short time frame. User input transfer rates should be sufficiently fast to enable timely transfer of data such that moderation can occur immediately and to ensure that time-sensitive user input is processed and queued for broadcast within seconds. Preferably, no more than 10 seconds should elapse from the time the user input is received to the moment it is available for moderation. All user input should be logged and archived, including moderation decisions. Archives of user input may be removed from the system on a regular basis, well before they grow in size to affect disk space. A regular schedule should be implemented to retrieve archives.

Referring to FIG. 6, as described above, user inputs are received in the network provider's domain 100 and formatted into data files or mySQL tables which are stored as raw user inputs in the VIS 175. A system for moderating user inputs comprises the steps of:
1. Viewing the raw user inputs as data files/database table contents at workstations 600 in the IBS provider's domain 105
2. Moderating the user inputs—approve or delete
3. Storing approved user inputs in the VISs 175, 195 in the live and standby broadcast hosting locations 110, 115 for use in broadcasting

Once raw user input has been successfully copied to the live VIS 175, then moderator software in the IBS provider's domain 105 reads this data directly from the VIS 175. At this point, the user input is ready for moderation. Once moderated, the user input is inserted to a second set of tables in the live VIS 175 that are accessible in the IBS provider's domain 105 for playlist decisioning.

The moderator software can be run on a storage server 165 in the IBS provider's domain 105 but may also be accessible over the Internet through a Web-based application. This allows the workstations 600 in practice to be located wherever might be convenient.

All access to the live VIS 175 by the moderator software, for instance consequent to changes made using the workstations 600, occurs via mySQL. All modifications to the live VIS 175 are copied to the backup VIS 195 using a mySQL subroutine. This ensures that the VISs 175, 195 are in line with each other ready for failover (described below) as required.

As well as the above monitoring and moderation, logs may be downloaded at predetermined intervals from the broadcast servers 180, 185 for reporting. For example the logs may be used for regulatory compliance (as played log), advertisers (as played log), or for internal analysis (interaction log).

Many broadcast and communication systems operate with latin character sets only. It is preferred in embodiments of the present invention that user inputs can be received and used in other types of character set, such as those supporting right to left as well as left to right languages and including, but not limited to, Chinese, Cyrillic, Hebrew, Arabic and like character sets. To achieve this the character sets must be supported throughout the system, from the RVIS which receives the original user input, to the VIS where the input is moderated to the IBS where the user input is broadcast. At the RVIS and VIS the sorting software and database must support the character set. At the IBS, the database, scheduling and broadcast software must support it.

3.6 Development

A test and development subsystem may be used for internal testing and for development of new or modified programme, daypart or channel graphics and/or formats. It should preferably have access to the broadcast servers 180, 185 but only to get access to content data and for publishing the final production-ready software onto the proofing server 400.

Embodiments of the present invention can offer an automated broadcast service with live or pre-recorded content 24 hours a day, 7 days a week, 365 days a year. Maintenance, upgrades, data archiving and any other potentially disruptive activity should be subordinate to this key objective. Channels will need to be updated with new data, the frequency depending on the content and the channels' requirements. In cases where the system does not allow updating and playout simultaneously due to hardware or software restrictions, the update process and acceptable down time should be documented and agreed in advance.

Referring to FIG. 10, a system for creating, testing and developing new or modified programme, daypart or channel graphics and/or formats and features comprises the steps of:
1. Securing log-in to a workstation 1000 at the IBS provider's domain 105
2. Creating and/or modifying software
3. Retrieving content (clips or video files for example) from the storage server 165
4. Taking user input test feed from a moderation workstation 600
5. Testing the new or modified software by running it with the retrieved content and test feed on the proofing server 400

New features and software developments should preferably be trialled on the proofing server 400 before being used in live broadcasts. Also preferably, the new features and software developments will be tested during periods when no channels require proofing. Any client software modifications can be trialled by loading software onto a non-production PC and tested against server components on the proofing server.

It will be understood from the above that the IBS provider's domain 105 in this embodiment provides several of the processes which can collectively be regarded as an asset processor. Apart from the function of moderating user inputs, all the functions described above can be regarded as part of an asset processor. The domain 105 also provides at least one of the user input processes which can collectively be regarded as a user input processor. For instance it provides user input display and editing facilities for moderation 600, 1100.

### 4. BROADCAST HOSTING DOMAIN 110

In the following description, only one broadcast hosting domain 110 is described but in use it is preferred that there is both a live and a standby broadcast hosting domain, for the reasons previously mentioned.

Referring to FIG. 1, broadly speaking, the broadcast hosting domain 110 broadcasts a programme schedule created substantially in real time from both pre-programmed scheduled events from the IBS provider's domain 105 and real time user inputs received via the network provider's domain 100. The final programme schedule can contain both pre-recorded programmes or live programmes. To do this, it comprises a scheduler 1200 and two IBS servers:
the VIS 175 for storing unscheduled material, particularly user inputs
the broadcast server 180 for storing scheduled material, content and static data such as algorithms for processing user inputs, and daypart definitions

The scheduler 1200 applies the static data in processing unscheduled material, particularly user inputs, which is then used to modify scheduled material and so put together a broadcast stream from a combination of scheduled and unscheduled material (which can contain both pre-recorded and live material). This might comprise for example music clips in a specified order with overlaid graphics, a live feed from a studio or the two used together to make up a programme. Output from the broadcast hosting domain 110, via the broadcast server 180, may be in the form of a serial digital interface to an uplink facility via a dedicated high-speed line or other suitable means.

The following describes just the live broadcast hosting domain 110 but the standby broadcast hosting domain 115 is the same.

In practice, the two servers 175, 180 support processes as well as data and this provides the following functionality 170 in the broadcast hosting domain 110:
scheduling
user input validation
user feedback
optionally, user input moderation
   4.1 VIS server 175

Referring to FIG. 11, three of these processes run on the VIS server 175. (Only the scheduler runs on the broadcast server 180.)

The VIS 175 provides a repository for all user input data coming from the RVIS 155. In many cases the RVIS 155 will be located at the network provider's domain 100, as described above, but in practice it may located elsewhere, or in some circumstances there may not be a need for the RVIS 155, all user inputs coming straight to a VIS 175. Data may be copied from the RVIS 155 to the VIS 175 and preferably the user input data is copied initially into tables. Preferably the tables contain unmoderated lists of various types of user input. In one embodiment, described above, the copying may take place using a mySQL subroutine. Preferably, a VIS 175 will be used across multiple channels. Each VIS 175 may have a reasonable number of connections to the IBS provider's domain 105 (eg for moderation), and the broadcast server 180 and the RVIS server 155.

Taking firstly the user input validation process 1105, this reads votes and requests as they arrive from the RVIS 155 to the VIS 175, determines whether the three digit numbers identifying items from a play or clip list are valid (that is, part of the play list) and places valid votes and requests in the appropriate table (vote or request) in the VIS database 1115 depending on what mode the IBS is in. Invalid votes and requests are discarded.

Since dedications consist of a message and a vote/request, the user input validation process 1105 also validates the three digit number portion of the dedication.

Taking secondly the user feedback process 1110, this is triggered to run each time a user sends a message or interacts in any way with the channel. Each user making an input receives an immediate acknowledgment from the channel and may receive further responses from the channel. Where a user input has been received at the network provider's domain 100 via IVR, the acknowledgement will be provided by an automated voice which thanks the user for their contribution. In the case of SMS, a message will be sent back to the user thanking them for their contribution and providing any other required information. The message back to the user is initiated by the user feedback process 1110 running on the VIS server 175 and executed via the network provider's domain 100. In the case of a user input received over the Internet, an email would be sent back to the user thanking them for their contribution and providing any other required information. VIS server 175 is provided with a Web server 1120 and the email response could be executed via the web server 1120.

Taking thirdly the moderation process 1100, this is preferably run from the IBS provider's domain 105 and moderation has already been described above. (Although shown in FIG. 11 as being installed on the VIS server 175, the moderation application could in practice be installed elsewhere, for instance in the IBS provider's domain 105.) Briefly, operators can review unmoderated lists of user input stored in the VIS database 1115 and approve, reject or modify the input items. Approval (modified or otherwise) may be recorded by copying the input item to another location in the VIS database 1115. Preferably a flag will also be set in the unmoderated list to show that it has been processed. Rejection may merely result in a flag being set in the unmoderated list to show that it has been processed.

Transaction rates from RVIS 155 to VIS 175 may exceed 100 transactions per second (tps). Coupled with querying from the broadcast server 180 and the moderation function, this could reach 200 tps. This rate should be manageable on a relatively small system.

4.2 Broadcast Server 180

Referring to FIGS. 12 and 13, the scheduler application 1200 runs on the broadcast server 180. The scheduler application 1200 has access to four types of content for scheduling:
unscheduled events 1300 stored on the VIS database 1115
scheduled events 1210 stored on the broadcast server database 1220
clips 1215 such as video clips, also stored on the broadcast server database 1220
external feed 1230 such as live video input, which arrives from a studio or other external source

The unscheduled events 1300 comprise the user inputs stored on the VIS database 1115.

Scheduled events 1210 include idents, interstitials, sponsored programmes and advertising. This list is prepared in advance and is scheduled to be broadcast at a specific time. The scheduler 1200 processes these events together with the unscheduled events 1300, applying appropriate algorithm(s) and/or daypart definitions 1225, 1205, to create the final broadcast stream with appropriate graphic overlay.

The broadcast elements 1215 as stored include both the clips themselves and clip lists. Clip lists are the lists of content available for users to interact with (requests, votes, etc). Clip lists can be prepared in advance. Clips might also include proforma broadcast elements such as tables or game presentations which will be updated for broadcast, according to an appropriate algorithm 1225, in response to user inputs.

Determination of the next file to play, and on-screen prompts, may be done by issuing a remote query to the VIS database 1115. Preferably a query will be issued periodically to determine the file to play algorithmically from the moderated user input lists. More frequently, a query may be issued to determine the prompts to display, by a simpler querying of these lists. This may return all the information for the prompt to display. It will also need to update the lists for any selected prompts to indicate that they have been displayed and processed. It is preferred that all access to the VIS database 1115 from the broadcast server 180 should be via mySQL subroutines located in the VIS database 1115 so as to minimise network traffic between them and to keep the broadcast server 180 insulated from the detail of how queries need to be run.

The scheduler 1200 continuously looks at unscheduled events 1300 which have arrived in the VIS database 1115 and at the scheduled events 1210 and selects the next piece of content 1215 to play whether it is pre-recorded or live and the appropriate overlay graphics and sends this information to a playout and graphics engine 1305. The playout and graphics engine 1305 takes instructions from the scheduler and plays out the appropriate content with associated graphics. If text or picture messages have been made for a particular item of content, they will be shown as well.

Once the relevant data is on the broadcast server 180, using the user inputs and any other relevant information contained in the system, at the end of every piece of content, the scheduler can determine what to broadcast next. It can incorporate video data (live and pre-recorded), audio data, text, images and graphics to build the final broadcast stream that is then distributed to viewers/listeners.

External feed 1230 is also available to the scheduler. This might supply for example advertisements or live news items. Advertisements might provide scheduled events and live news items might provide unscheduled events. For example, advertisements might be stored as scheduled events 1210 on the broadcast server database 1220 but they might instead be supplied from an external advertisement server and these can be triggered by the IBS at the appropriate time to play out the advertisement. Live news items meanwhile might arise as unscheduled external events because unscheduled events 1300, particularly votes or requests, which have arrived in the VIS database 1115 indicate that the next piece of content should be taken directly from an external live news source. In this case, the scheduler needs to insert material from the live news source as an unscheduled event.

In order to insert externally fed material, the system also comprises a trigger that can be used to trigger input to a broadcast from outside the system. In one embodiment a code is inserted into the vertical blanking interval (VBI) to trigger the insertion of materials, for example advertising breaks. The material can be inserted either by playing content with the appropriate lines in the VBI or by sending a general purpose interface (GPI) to a system which will do the insertion. Such systems are commercially available, such as the Oliver V offered by Softel Ltd. The second system, using a GPI, is more robust. For example the broadcast system could send an appropriate GPI to a Softel Ltd box at the end of a clip which is played immediately before a proposed ad break. The GPI could be sent using a digital I/O card, the Advantech PCI-1750, or the like.

At certain periods during the day there may be only a small number of inputs from users. In this case, the scheduler may apply a rule causing it to revert to appropriate content from a preset content list and broadcast that material.

As mentioned above, in order to make scheduling decisions, the scheduler application 1200 also has access to daypart definitions 1205 and user input algorithms 1225, these both being stored on the broadcast server database 1220. The scheduler application might be run so that interactive broadcasting is available 24 hours per day, for time limited dayparts such as a period of days, hours or minutes, or for an individual programme.

In an example of a programme for interactive broadcasting, the programme may start with an introduction, move on to a set of video clips and finish with a closing session. Different parts of the programme might be available for interactivity with users. For example, users might be able to post messages on screen throughout the programme, post dedications on screen while specified video clips are playing, and vote or make requests in relation to the video clips at any time until the closing session starts.

The scheduler application 1200 will show this programme by scheduling the introduction and closing session. During the introduction and closing session, it will poll the VIS database 1115 for any tables containing messages. If moderated messages are present in relation to the relevant channel, they will be scheduled for immediate screening. During the playlist portion of the programme, the scheduler application 1200 will additionally poll the VIS database 1115 for any tables containing the code identifying a clip. Depending on the current daypart definition, such a table might indicate a dedication, a vote or a request. If there is a message associated with the code, text and/or picture, then the scheduler application 1200 will schedule screening of the message concurrently with the identified clip. If the daypart definition indicates that votes are expected, the scheduler application 1200 will treat any codes without messages as votes. That is, it will run a voting algorithm and, usually, play a clip with most votes. If the daypart definition indicates that requests are expected, the scheduler application 1200 will treat any codes without messages as requests. That is, it will play the next requested clip from a list.

As well as scheduling user inputs, the scheduler application 1200 will also be required to post information on screen which users need, such as the fact that the broadcast is interactive and whether voting is open or closed. There may also be descriptive or promotional information which needs to be shown synchronously with individual clips.

This can be polled from database tables in the broadcast server database 1220 in a manner analogous to dealing with user inputs.

In one variation, the unscheduled events 1300 might also comprise fresh news items which a broadcaster has received not from a user but for instance from a news channel or a news service. This arrangement supports a service in which users can vote for fresh news or gossip items to be broadcast as they arise, such as sports results, or they can be posted automatically as they are received by the broadcaster as part of a programme.

In general, it is functionality running on the broadcast server 180 which decodes the video, audio and text and other data and turns it into a feed to send to the cable head end, satellite uplink or whichever distribution method is required by the broadcaster. The broadcast server 180 comprises the systems that stream the content through to the distribution function (ie. the uplink provider). The broadcast server 180 is a core part of the system that should be kept running and broadcasting content even if other parts of the system have gone down.

Preferably the broadcast server 180 performs only the tasks that it needs to in order to (a) select the files or live video input it needs to play, (b) stream the selected file or live video at the appropriate time, (c) log its activity, and (d) provide a monitoring and control override capability back to human operators. Preferably, there are no regular updates to this server, all such updates being handled by the VIS 175.

In the above, the broadcast server 180 is generally described in relation to screen-based broadcasts. However, a broadcast may be output to viewers in one of a number of formats depending on the broadcasters' infrastructure, distribution platform and/or the receiver's system.

Embodiments of the present invention can play out an integrated broadcast stream in one of a number of analogue and digital formats of varying quality, including but not limited to, SDI with embedded audio, SDI with separate AES/EBU audio, analogue component and separate analogue audio, composite video with separate analogue audio, SVHS with separate analogue audio, DVI or as an IP based video/audio stream.

Embodiments of the present invention can be designed to work with many broadcast distribution platforms, including but not limited to analogue or digital satellite, cable or terrestrial, closed broadcast systems such as those found in, but not limited to hospitals, hotels and bars, IP networks (TV over IP) and fixed (DSL, cable, fiber) or wireless (Wifi, Wi-Max) narrowband and broadband networks.

The broadcast hosting domain 110 can be deployed in many different ways depending on each broadcaster's requirements and other issues such as, but not limited to, space in the playout centre, available budgets, bandwidth available for distributing the broadcast, geographical limitations, technical limitations. The present invention is flexible enough to accommodate such diverse requirements.

Four examples of how the broadcast hosting domain may be deployed are described below, with reference to FIGS. 1, 11, 12 and 13.

1) Local deployment: In this deployment all components of the broadcast hosting domain 110 are located in the same physical location. The playout and graphics engine 1305 may output the broadcast as an SDI stream with embedded audio for distribution via a digital satellite network.

2) Hybrid deployment: In this example the components of the broadcast hosting domain are located in two places, a broadcast centre and a data centre. The scheduler application 1200, clip table 1215 (which includes all available broadcast elements) and playout and graphics engine 1305 reside in the playout centre. The remaining components of the broadcast hosting domain 110 reside in the data centre.

The scheduler 1200 accesses the VIS database 1115 and broadcast server database 1220 (with the exception of the clip table 1215 which resides with the scheduler 1200 as described above) via a secure communications link such as a DSL or t1 line. The scheduler 1200 decides what should be broadcast and the playout and graphics engine proceeds to playout the appropriate video, audio and graphics.

In this example the playout and graphics engine 1305 is playout out an analogue component video signal with separate analogue audio signal which are distributed over an analogue cable network.

3) Remote to PC deployment: In this example the scheduler 1200 and playout and graphics engine 1305 are in the location where the broadcast will be played out. The rest of the broadcast hosting domain 110 components are located in a secure data centre. The scheduler 1200 accesses all required VIS 175 information and broadcast database 1220 remotely from the data centre via a secure communication link.

The information (such as user inputs 1115, clip table 1215 and daypart definition table 1205) is received by the scheduler and given to the playout and graphics engine 1305 for playout.

In this example the playout and graphic engine 1305 is playing out an analogue composite video signal and separate analogue audio signal for distribution over a closed network in a hospital.

4) Remote to STB deployment: In this deployment all components of the broadcast hosting domain are located in a secure data centre. In the playout centre there is a Set Top Box capable of receiving and outputting Windows Media, Real Media or other types of video/audio streams.

The playout and graphics engine 1305 component of the broadcast hosting domain 110 outputs the broadcast stream as a Windows Media, Real Media or other type of video/audio stream. This is transmitted to the STB in the playout centre via a standard IP connection. The STB receives the video/audio stream and outputs the broadcast. In this example broadcast output by the STB is distributed via a broadband connection to viewers' homes.

4.2.1 Algorithms

Clearly the nature of the algorithms which the scheduler 1200 uses in processing the user inputs at least partly determine the response of the IBS to user inputs. Examples of simple algorithms that might be used are as follows:

Scheduling Algorithm

If (current_time + next_clip_time) >= next_scheduled_clip then

Send next scheduled clip to playlist

Else

If (request_count = 0) then

Send clip from clip play list

Else

Send next request

End If

End If

FIFO

Request arrives

Check last time played−X minutes

Check if already requested In request list−Y minutes
If not requested Y=0
Else Y=next slot

If X+Y>=minimum time between plays
Write to request play list

Else
Do not write to request play list

Voting—triggered every N minutes

Every N minutes

Check vote count for top M videos

For each of the M videos
check last time played−X min
check if already in request list+when−Y min
If X+Y>min_time put in req list Else drop

Reset counters

Request/Voting algorithm

If (Requests = False)

Do nothing
Wait until time to count votes

If (new_clip >= 1) AND (Requests = False) then

Write request to request/vote list

Else

If vote_counter = minutes_between_votes then

Calculate votes, note last vote position
Update request list from top with correct # clips

Else

Do nothing

End if

End if

Dedications

If dedicated clip is already requested it can get shown with clip (<X deds) then
Do not add clip to request list
Add dedication to dedication list

If dedicated clip is not already in the request list
Put through normal clip validation
Add dedication to dedication list

4.2.2 Daypart Definitions

Daypart definitions are mentioned above. They provide rules which control the behaviour of the scheduler over different time periods. The time periods may be more than one day long, in which case for example the behaviour of the scheduler might be different at weekends. Alternatively, the time periods may be less than one day long, in which case for example the behaviour of the scheduler might be different in the evenings.

Using daypart definitions, it is possible to trigger the scheduler to schedule items from a different list of available content, giving viewers increased choice and making the dayparts more interesting. It would be possible to broadcast an event based channel that promotes events of a time limited duration, such as the launch of a film or a consumer exhibition. Each “event” could be broadcast for between one month to three months. In the case of dayparts less than a day long, it would be possible to promote several events each day, by giving each event its own daypart. Each daypart could inform viewers about a different event and allow different types on interactivity.

Daypart definitions can also be used to determine the mode in which the scheduler is operating. For example at some times of day, user inputs comprising just a three digit code might be treated as a request while at another time of day the same user input might be treated as a vote. The mode in which the scheduler is operating may cause it to reject some types of user input and only accept for example votes and/or messages.

In practice, using daypart definitions to control the behaviour of the scheduler, the same user input could be caused to have quite different effects. For example, at some times of day a vote may be a discard vote instead of a vote in favour of content. In this example, the response of the scheduler might be to block any further selection of an item of content which has received most votes. Users would be advised of the current format of an interactive broadcast, and therefore the effect their vote could have, by on-screen text triggered by a daypart definition at an appropriate time. On-screen text and promos can also be used to advise users in advance that a particular format will be applied for the duration of a particular daypart.

A daypart definition will therefore generally contain a time period for applying the daypart rules, plus the rules (or at least pointers or references to the rules) to be applied by the scheduler. These rules might for example dictate one or more locations where the scheduler looks for items to schedule, plus how the scheduler deals with items found in those locations.

Simplified examples of daypart definitions are given below, although it will be understood that the definitions in practice will be more detailed and may control additional IBS mechanisms not included below, such as rules for sending immediate one-to-one feedback to the user on receipt of an input.

Scenario 1:

Live interactive chat show—a host and guests discuss a specific topic while viewers express their opinions by sending in text messages. The messages are commented on and discussed by the host and guests.

The daypart definition for this might contain
times of day defining a daypart period corresponding to a chat portion of the show (eg 12:00 to 13:30 Monday to Friday)
Rule 1—for scheduling IBS information to users, the scheduler should access a first database location where items of IBS information are stored
Rule 2—the items of IBS information should be overlaid on a first specified portion of the screen in turn for a fixed period of (say) three minutes
Rule 3—for scheduling moderated user messages, the scheduler should only access a database location where moderated messages are stored
Rule 4—the content of each moderated message should be overlaid on a second specified portion of the screen in turn for a fixed period of (say) five seconds.
Rule 5—if the number of moderated messages stored in the database goes above an upper threshold, change the “Rule 1” database location (IBS information) to a first substitute database location
Rule 6—if the number of moderated messages stored in the database goes below a first lower threshold, change the “Rule 1” database location (IBS information) to a second substitute database location
Rule 7—if the number of moderated messages stored in the database goes below a second lower threshold, terminate or change the daypart definition currently in use
Rule 8—five minutes before the end of the daypart period, change the “Rule 1” database location (IBS information) to a third substitute database location

This daypart definition enables the scheduler 1200 to give IBS information (eg information about the current programme, options available and telephone numbers to ring) to inform users how to send in messages, and it enables the scheduler 1200 to display the messages. It also allows the scheduler 1200 to respond if there are too many or too few messages, for example by informing users and potentially by giving an incentive to send messages or even by terminating the chat portion of the show.

Scenario 2:

Late night dance daypart, playing dance music based on viewers votes. Text and picture messages are also displayed as part of the broadcast.

The daypart definition for this might contain
times of day defining a daypart period corresponding to a dance period of a show (eg 23:00 to 02:00 Thursday, Friday and Saturdays)
Rule 1—for scheduling IBS information to users, the scheduler should access a first database location where items of IBS information are stored
Rule 2—the “Rule 1” items of IBS information should be overlaid on a first specified portion of the screen in turn for a fixed period of (say) one minute
Rule 3—for scheduling dance music based on user inputs, the scheduler should access a database location where votes are stored
Rule 4—the scheduler should apply a specified algorithm in processing the votes to select dance music to schedule
Rule 5—for scheduling messages based on user inputs, the scheduler should access a database location where moderated messages are stored
Rule 6—the content of each moderated message should be overlaid on a second specified portion of the screen in turn for a fixed period of (say) five seconds.
Rule 7—for scheduling dedications based on user inputs, the scheduler should access a database location where moderated dedications are stored
Rule 8—the content of each moderated dedication identifying a piece of music should be overlaid on a third specified portion of the screen in synchronism with the piece of music for a fixed period of ten seconds
Rule 9—if the number of dedications identifying the same piece of music goes above a threshold, reduce the “Rule 8” fixed period to five seconds
Rule 10—if the number of moderated messages stored in the database goes above an upper threshold, change the “Rule 1” database location (IBS information) to a first substitute database location
Rule 11—five minutes before the end of the daypart period, change the “Rule 1” database location (IBS information) to a second substitute database location

This daypart definition enables the scheduler 1200 to inform users how to send in votes and messages, to schedule music in accordance with the votes and to display the dedications and messages. It allows the scheduler 1200 to respond if there are too many messages but, in this case, it does not matter if there are too few messages as the dance music will continue to be played in accordance with votes received. The “Rule 2” algorithm can be used to determine what the scheduler 1200 will do if there are no votes, for example reverting to a default playlist. If one piece of music inspires a lot of dedications, Rule 9 enables the scheduler 1200 to screen them more quickly.

Scenario 3:

Weekend shopping segment—viewers vote for which products they would like to see shown and either request further information or purchase the products via SMS, IVR, a call centre, or an electronic communications network, for example the Internet.

The daypart definition for this might contain
times of day defining a daypart period corresponding to the shopping segment (eg 08:00 Saturday to 00:00 Sunday)
Rule 1—for scheduling IBS information to users, the scheduler should access a first database location where items of IBS information are stored
Rule 2—the “Rule 1” items of IBS information should be overlaid on a first specified portion of the screen in turn for a fixed period of (say) four minutes
Rule 3—for scheduling images or video clips of products based on user inputs, the scheduler should access a database location where votes are stored
Rule 4—the scheduler should apply a first specified algorithm in processing the votes to select products to show
Rule 5—for scheduling information requested in user inputs, the scheduler should access a database location where information requests are stored
Rule 6—the scheduler should apply a second specified algorithm in processing the “Rule 5” information requests to select information to show
Rule 7—for processing purchase requests, the scheduler should access a database location where purchase requests are stored
Rule 8—the scheduler should apply a third specified algorithm in processing the purchase requests firstly to validate the content of the purchase requests in relation to stock, secondly to check that relevant stock is still available and thirdly to route the purchase requests to an appropriate destination
Rule 9—for scheduling information to users concerning stock levels, the scheduler should access a database location where purchase requests are stored
Rule 10—the scheduler should apply a fourth specified algorithm in processing the purchase requests to select stock level information to show
Rule 11—five minutes before the end of the daypart period, change the “Rule 1” database location (IBS information) to a substitute database location

This daypart definition enables the scheduler to inform users about the shopping segment and how to send in information and purchase requests. It allows the scheduler 1200 to respond by displaying requested information. It also allows the scheduler 1200 to run an algorithm in relation to the purchase requests so that it can display information to users about remaining stock levels.

It will be understood from the above that the broadcast hosting domain 110, 115 in this embodiment provides at least one of the user input processes which can collectively be regarded as a user input processor. For instance it provides user input validation 1105 and feedback to users 1110 in response to inputs. The daypart definition for Scenario 3 above is interesting however in that it shows an example where the software providing the scheduler 1200 can in practice also provide a tool for user input processing. That is, rules 7 and 8 trigger the scheduler 1200 to validate and forward purchase requests to an appropriate destination such as a customer service department of an appropriate supplier. Alternatively, the scheduler 1200 could transfer the purchase requests to another application such as the tool for user validation 1105.

It will also be understood that the broadcast hosting domain 110, 115 in this embodiment provides an asset store as mentioned above, by means of the broadcast server 180. For instance, as described the broadcast server 180 stores scheduling criteria as well as encoded video/audio broadcast elements. The scheduling criteria here comprise in particular daypart definitions, algorithms and playlists.

Referring to FIG. 14, one possible screen layout is shown. The screen layout will depend on the programme being broadcast and on the stage reached in the programme, since both factors are likely to require different numbers of screen elements to be present. As seen in the figure, the screen elements may be for synchronous or asynchronous presentation with clips and are likely to comprise any one or more of the following:
Bug—The graphic logo of a channel. This will often always be on.
Content Info—information that is displayed at the beginning and end the content that is being broadcast.
Sales Ticker—a continuous ticker through which products are promoted to users. It is preferably asynchronous with the content.
Text and picture messages—will often be content specific and are therefore often synchronous with the content. Messages are often asynchronous.
Prompts—are designed to prompt users to interact. Content numbers may be displayed and mixed with lines such as “give us a call” and “send a message to a mate”. This graphic may run asynchronously to the content.

All graphic elements can have their colour, location and font changed and can be enabled and disabled, depending on the programners' requirements. Graphic elements may also be imported into the system using standard graphic file formats.

### 5. PLATFORM, FAILOVER AND ARCHIVING

5.1 Platform

Referring to FIG. 15, an outline is shown of platform elements which might be used to support an embodiment of the present invention. (In the arrangement of FIG. 15, the network provider's domain 100 is not shown and thus there is no RVIS 155 shown.)

As can be seen, the IBS provider's domain 105 uses a Microsoft Windows environment which sends proofed broadcast materials and schedules for storage in the broadcast hosting locations 110, 115. In practice, the delivery of proofed video data to the broadcast hosting locations 110, 115 occurs as follows. Video data is encoded and edited as described above with reference to FIGS. 2 and 3, using suitable software and workstations 205, then stored on the storage server 165. The video data then goes from the storage server 165 to the proofing server 400 for proofing. When proofed, the video data is sent directly from the storage server 165 to the broadcast servers 180, 185 in the broadcast hosting locations 110, 115.

Wide area networks 1500 are used between the IBS provider's domain 105 and the broadcast hosting domains 110, 115 and local area networks 1505 are used within the broadcast hosting domains 110, 115. Communications from the network provider's domain 100, and moderated user inputs from the IBS provider's domain 105, both of which may comprise damaging content since these include user inputs which could for example carry a virus, are received at the broadcast hosting locations via a firewall 1510.

The server operating system could alternatively be for instance based on the Apple Mac operating system.

Preferably a dedicated RAID 5 or 0+1 disk array should be used to store the media files that will be played from the broadcast server 180. Preferably, separate internal mirrored disks should house the operating system, applications and database (such as mySQL).

Tests have shown that a single processor platform performs adequately for one channel but dual processor or other suitable platforms may be used. Whilst it is possible to run multiple channels on a single server, it is preferable not to do so but rather to use one processor platform per channel.

In one embodiment the broadcast server platform comprises a personal computer having at least one HDD with MPEG-4 encoded video and encoded audio for the channel. A Specialised Optibase card is used to decode the video and audio data and turn it into a broadcast feed which is then sent into the cable head or satellite uplink.

It might be preferred that each of the broadcast, VIS and RVIS servers 180, 175, 155 is dual-processor to enable more effective handling of all of these connections. Concerning the storage server 165, it may be preferred that this is a network attached storage (NAS) device or, more simply, a personal computer server with attached disk. Attached storage might be in RAID 5 or 0+1.

A database is located on the storage server containing local copies of playlists, programming decisions, weightings, etc. to enable broadcast asset management. It should preferably also store a table of the stored video files on this server. The database may have very low activity. A mySQL database might be suitable.

5.2 Failover

Referring to FIG. 7, in the event of failure affecting the live broadcast hosting domain 110 but not the standby 115, it is preferable to be able to achieve a switchover from the live to a standby domain 115 in the order of five seconds. If the problem is in the broadcast server 180 or scheduler application 1200, it is possible to initiate reconfiguration of the previously live VIS 175 to act as backup to the newly live broadcast hosting domain 115. Hence a switchover procedure might comprise the following steps:
1. Channel monitor 700 shows problem with broadcast
2. Switch is initiated from the live to the (already synchronised) standby broadcast hosting domain 115
3. Alert raised for urgent fix in the previously live broadcast hosting domain 110
4. The VIS 175 in the previously live broadcast hosting domain 110 converted to backup to the newly live broadcast hosting domain 115
5. The previously live broadcast hosting domain 110 is fixed with on-site spares
6. Switch is initiated back to the previously live broadcast hosting domain 110
7. On-site spares replaced.
   5.3 Archiving

Referring to FIG. 8, material can be archived from the data storage provided in the broadcast hosting domains 110, 115. In particular, old user inputs, programming data and log files can be archived. For the live broadcast hosting domain 110, this comprises the steps of:
1. Check that the domain 110 is in a state to cope with archiving (not broadcasting)
2. Run archive program to transfer data to DVD
3. When archive is complete and verified, remove DVD and label.
4. File DVD in appropriate archive storage area

All old data can be removed from relevant servers whilst a broadcast continues. Archiving requirements for each server would consist of the following:
Broadcast server 180—video files no longer required in schedules; activity information logged to the database (old schedules and static database information is automatically removed on a rolling basis as the data is copied from the proofing server 400—if an old schedule no longer exists in the proofing server 400, it will no longer exist on the live and backup broadcast servers 180, 185 after copying.)
VIS 175—raw or unmoderated user input; moderated user input
RVIS 155—raw or unmoderated user input

All database archiving can be initiated on a regular basis or as required, and each system's data is independent of others. There is no requirement even for live and backup to be in sync as far as archiving is concerned.

Database data will be removed via a mySQL subroutine that can be initiated on a regular basis—for example daily for user input and weekly for activity logging. Particular attention should be paid to the need for offline retention of data either for analytical or auditing purposes, or to respond to client issues. Options for this include: (a) a further online mySQL database, and (b) export files compressed to disk. Such database data could be stored ultimately on CD or DVD. The mySQL subroutine which is set up to copy from VIS 175 to VIS 195 will handle the removal of data from a backup VIS 195. Deletes from the RVIS 155 should not be copied to the VISs 175, 195.

Video file data can be removed in a similar way—regularly or on request via a script. This script should query the database first, however, to ensure that no video files are removed which exist in the current or future schedules. Alternately, video files could be removed at specified points in a scheduling process which avoid removing files still required.

Overall, the IBS thus provides a flexible interactive platform for asset management and user input processing that also supports real time interactivity and may build a broadcast stream in real time for transmission. The broadcast stream may consist of video, audio, text and/or graphics properly synchronised. The IBS may support pre-recorded content as well as a live feed. It also supports interactivity via IVR, SMS, internet, STB and other communication systems through a standard interface.

A version of the system for streaming over the Internet, for a retail or mobile environment preferably outputs a composite or other appropriate video signal. This signal may then be encoded and streamed over a broadband or narrowband network, a closed network or a mobile network.

### 6. EXAMPLES OF EMBODIMENTS OF THE INVENTION IN USE

The following are examples of possible applications for embodiments of the invention.

6.1 Digital Radio

Listeners can send text messages via their mobile phones which can be seen by all other listeners on the text display of the digital radio. The interactivity can be used to receive questions from listeners and then display some of the answers, let listeners vote for the music they would like to hear and broadcast information about the songs or programmes being broadcast.

If SMS is used for user inputs, the IBS for the digital radio station could receive the listener messages in one of two ways: directly in to the VIS 175 or via a network provider. In either case the numbers can be set up in advance and the viewers notified via promos on the station.

6.2 Broadcast Television

The system of the present invention can be used by television channels to broadcast on a variety of broadcast systems/platforms including: analogue television, digital television, cable, satellite and DTT. The interactivity of the present invention can be used throughout the whole or part only of a broadcast schedule and for all or only some of the channels being broadcast, as desired by the programmer. Such channels can include advertising and sponsorship as well as specific programmes (as desired by the broadcaster).

Viewers can send votes, text messages and picture messages via their mobile phones or set top box and can vote via premium rate telephony. The messages can be broadcast to be seen by the whole viewer base. The interactivity can be used to receive and deliver questions and answers in either direction between presenters and viewers (in a live programme), let viewers vote in a live poll and generally engage viewers in a two way dialogue. Viewers could be asked to vote for topics to be updated as an overlay to a broadcast, such as selected sports results to be delivered while they are watching another programme or such updates could be part of a particular programme.

Viewer messages and dedications could also or alternatively be automatically posted to a website for all viewers to review at their leisure. In such an embodiment, the system will have two outputs, a first output for scheduled broadcast elements for broadcasting and a second output for processed user inputs such as moderated messages and dedications to be posted to the website. (It will be understood that this option can apply not just to broadcast television but to any embodiment of the invention.)

The level of interactivity may be altered from time to time. During any period of full interactivity users may be able to directly influence the programming by voting for the clips that they want to see. Through their votes, users watching the channel decide what will play.

The programming can be any video material but preferably is presented in short segments. Examples of appropriate genres include music videos, movie trailers, adult entertainment, travel, shopping, education, business-to-business and many others.

If the broadcaster desires that only specific parts of the broadcast are to be interactive it is able to limit the interactivity to as many hours per day as required and can be shown at pre-selected times of the day, for instance using daypart definitions. For instance, it would be possible to broadcast two six hour dayparts on a channel during the course of a twenty four hour period. Each daypart could give viewers a different list of clips to choose from and allow different types of interactivity. Any viewer who already received the television channel would be able to receive the six hours interactive music daypart.

If text messaging is used for user inputs, then the television would broadcast to viewers the phone numbers or short codes to which messages should be sent. The numbers or short codes would be provided by a network provider and set up in advance of the broadcast. These could be premium SMS and MMS services and the viewers would be charged a fee for sending the messages which would appear on their mobile phone bill. The viewers know what interactive options are available to them because they are reminded by promos and text screens which are broadcast with the channel.

If a set top box remote control is used to provide interactivity then the television programme could tell viewers how to use it to interact with the programme. The interactive functionality could be provided by the cable operator or other supplier and set up in advance of the broadcast. This would be a premium interactive service and the viewers would be charged a fee for sending the messages which would appear on their monthly cable bill. The viewer sends a message by entering the set top box application and using the numeric keypad on the remote control to type a message in the same way that it is done on a mobile phone. If the message is as desired, the viewer then proceeds to send the message and the set top box sends the message via its return path. When a viewer sends a message to the channel, it would first be received by the set top box and then transmitted to the cable operator's interactive infrastructure. From there it would be sent to the RVIS 155 and from the RVIS 155 to the VIS 175.

6.3 Business-to-Business Television

In one embodiment the present invention can be used for subscription channels. It enables particular groups to be targeted, for example, dentists, patients in a doctor's waiting room, patrons in a pub and any other specific group that has a need for targeted information. Interactivity can be used to receive questions from users and to poll them as to their preferred programmes and features. The smaller the targeted community, the more critical dialogue is with that community. As in the broadcast television example described above, in addition to being broadcast on the channel, viewer comments and questions could also or alternatively be put on a dedicated website, a digital or analogue teletext page or other suitable page for the specific community to view at any time.

This example can be deployed as either a single channel or multiple channels to multiple locations. In the case of a single channel, it can be one channel that is broadcast in the waiting rooms of doctors' surgeries across the country. In the case of multiple streams, it can be an entertainment channel broadcast to concert venues with each channel localised for a particular venue.

6.4 Internet

The system can also be used to broadcast channels or programming over narrowband and/or broadband Internet, Intranet, Extranet and LAN networks. These channels can be as interactive as desired and can be applied to a similarly broad range of content as other broadcast applications. One Web site could be used both to broadcast the channel and for user interactivity. User inputs could be received at the RVIS 155 or directly at the VIS 175.

Typically, because the cost of distribution is lower than in broadcast television, it is possible to launch a bouquet of services catering to niche markets that would otherwise be too small to target economically.

Again, due to the lower cost of distribution multiple interactive VOD channels can be broadcast. The number of channels depends on the number of internet users requesting content. These channels could contain sports or adult content, and each viewer could see the same or different video/audio streams and the same or different viewer interaction (such as text messages, webcam streams, etc) depending on the requirements of the application.

Alternatively, the Internet could be used to field user inputs to a broadcast television channel. The television channel would broadcast an internet address to which users should point their browsers to interact with the channel. At this Internet address there will reside a web site that supports the desired interaction. This web site should be set up in advance of the broadcast. An internet-based payment mechanism could be used to charge the viewer for interacting with the channel.

6.5 Retail and Event Based

The system can be used to broadcast within retail environments such as department stores, post offices and shopping centres. Again, any content can be used but in this application the emphasis is on promotional material to encourage users to purchase. The interactivity can be used to encourage shoppers to enter competitions, to select what products they would like to see promoted and to make purchases. In this last example of user input, the IBS would respond by passing details to a fulfilment house to supply a purchased product.

It is possible to create a free to air shopping channel where viewers either vote for the products they would like to see put up for sale. Or the broadcast system can automatically decide what product clips to broadcast based on the volume of telephone calls the channel is receiving. SMS could be used by viewers to request more information or to purchase products.

An interactive channel could be narrowcast into a retail chain's stores during opening hours and seen on televisions placed throughout the stores. It would be possible to create a dedicated channel for each individual high street location and customise it to that particular location's inventory situation and/or local customer demand.

It is also possible to create an interactive channel dedicated to promoting events. In this case the channels interactivity could be used by viewers to register their interest in the event and receive more information and/or to purchase tickets for the event. Using the interactive nature of the channel, for instance the daypart facility, numerous events could be promoted each day.

6.6 Mobile Devices

To broadcast an interactive channel to wireless mobile devices such as PDAs, handheld computers and mobile telephones via 2.5 G and 3 G platforms. In this application users can subscribe to various services that will provide them with dedicated interactive channels or daily or hourly video updates in specific genre areas.

One good example is a television based game that can also be broadcast to a mobile device. When a player is not home, but would like to participate in the broadcast they may do so using their mobile device.

6.7 Broadcast Booking

As mentioned above, the user making a user input to the IBS preferably always receives an acknowledgement. This can be supplied by the user feedback application 1110 on the VIS server 175. In a broadcast booking service, a user might submit a broadcast element which they do not need to see on screen immediately but for which they want to know a broadcast time. For instance, they might want to know that a message or dedication they have submitted firstly is going to be broadcast and secondly is going to be broadcast at a fixed time or within a certain time window so that they can assemble a target audience. To support such a service, the user feedback application 1110 may be triggered on receipt of a user input to interact with the scheduler application 1200 to obtain broadcast confirmation and a broadcast time which can be delivered immediately in an acknowledgement to the user of their input.

In any interactive system, response behaviour can clearly affect the user experience. If a user submits a request for a message to appear on screen for example, that user will appreciate either immediately knowing the broadcast time as mentioned above, or seeing the message appearing promptly on screen. In either case, the interactive system preferably demonstrates a timely response to the user. In general, embodiments of the present invention have the advantage that they can present a substantially realtime response to users, from the time that the user delivers an input to the time that the user receives a response. However, the response time will usually be governed in practice by various factors, such as the volume of user input at the time, the type of user input and how the user input is displayed. For example with voting, all votes might be tabulated at the end of each clip irrespective of how many votes there are. With messages, if there is a high volume and the IBS applies a rule that they are therefore displayed for five seconds each instead of ten seconds, the response time will deteriorate. However, embodiments of the present invention can usually meet a target response time of the order of ten minutes or less, in substantially all circumstances. “Of the order of” means here “within a couple of minutes of”. In some circumstances, embodiments of the present invention can meet a target response time of two minutes or less, or even ten seconds or less, and can thus appear to give an immediate response to user input.

Response time in this context means the time between receipt of a user input and a response by the system based on the user input (either on screen or via return communication). Usually, this will mean the scheduler application 1200 also completes a scheduling operation in relation to the user input. The completion of a scheduling operation puts the system in a position to show a response to the user based on the user input. The response shown might take different forms, such as transmitting scheduling information in reply to the user input or actually broadcasting a broadcast element based on the user input.

6.8 Personalisation

In another embodiment it would be possible to create on demand personalised channels so that viewers could see what they want when they want. This could be a single channel broadcast to all viewers (which could be driven by viewers' votes, for example) or a different channel for each viewer based on their specific requests.

6.9 Asset Management

In another embodiment it would be possible to use functionality primarily described above as being in the IBS Provider's domain 105, supported by an asset store equivalent to the broadcast server 180, on its own to perform the asset management of an existing or new channel. It could perform the following tasks: encoding and storing broadcast materials, programme scheduling and finally transferring broadcast materials to a broadcast platform. It could also be responsible for retrieving logs and archiving broadcast materials and programming schedules.

6.10 Interactive Gaming

In another embodiment it would be possible to use the interactive nature of the system to broadcast a single or multiplayer game, the results of which are seen on the screen, that viewers play via one or other communication network (SMS or IVR for example). In this example, the user input processor extracts data from one or more user inputs and creates or updates a proforma broadcast element which provides a current on-screen version of the game. The proforma broadcast element could be loaded via the asset manager using the storage server 165 and supplied to the broadcast server 180 for use in a broadcast. It can then be selected by the scheduler 1200 at broadcast time and updated algorithmically by a function of the scheduler 1200 acting as part of the user input processor.

The interactive game can be a community based game wherein all viewers see the same channel and many players can play at one time. It can alternatively be a one to one game where each viewer is playing the computer of one other player and as such multiple channels of the game are output at the same time.

6.11 User Input Moderation, Analysis and Aggregation

In another embodiment it would be possible to use the RVIS 155 and VIS 175 on their own to receive user input and perform moderation, analysis and aggregation functions. The user input can then be fed into a broadcast server or used for a non-broadcast application such as a marketing campaign or retail promotion.

6.12 Community Based Interactive Games

In another embodiment it would be possible to use the system to broadcast interactive community based games. These are games where a community of viewers, either in teams or as individuals, plays a game that is broadcast for all viewers to see. Such games encourage viewers to not only watch but to interact and participate directly. This results in higher levels of consumer satisfaction and creates a much stronger sense of community that can be further exploited by online activity and one-to-one marketing.

The community in question could be made up of viewers in their homes, in which case a single channel would be broadcast to all homes. Each community could also be made up of patrons in a pub, where multiple streams would be broadcast, one to each pub.

6.13 Leisure and Hospitality Based

In another embodiment it would be possible to create an interactive channel for a hotel, pub or other hospitality environment. The interactive nature of the channel means that the channel is controlled by the patrons in the pub or club. Patrons experience a channel that enables them to select the content they want to see, and also express their views and opinions about any topic, by sending SMS messages. This could be a single channel broadcast to all locations, a different channel broadcast to each location or even a different channel broadcast to each viewer, depending on the requirement of the application.

6.14 Closed Broadcast Systems

In another embodiment the present invention can be used to create dedicated interactive channels for closed broadcast systems such as those found in, but not limited to, hotels and hospitals. The channel would be controlled by the hospital patients or hotel guests who would control the content that is broadcast and be able to send text messages or other interactive input that would be seen by all viewers.

In the case of a single channel this could be described as a community VOD channel. In the case of multiple channels each hotel room or each hospital ward could receive a different channel based on the viewers' choices.

6.15 TV over IP

In another embodiment, the present invention can be used to create and broadcast an interactive channel over an IP network. Such a TV over IP channel would enable a broadcaster to reach a very large audience cost effectively both through their personal computers and their televisions. This could be used to broadcast a single channel to a large audience or multiple channels to multiple smaller audiences.

6.16 Video on Demand

In another embodiment, the present invention can be used to create a Video on Demand system where the content that is requested by the viewers is immediately broadcast by the playout and graphics engine 1305 together with viewer input received from the VIS 175. The number of channels broadcast depends on the number of viewers at any particular time.

6.17 Viewer Input Processor

In another embodiment of the present invention, the broadcast hosting domain 110 can be deployed without the playout and graphics engine 1305. In this case, an external playout and graphics engine is used which receives its instructions from the scheduler 1200. So while the invention is processing the viewer input and still scheduling the viewer input, clips or both, the actual graphics and playout is done by an external system. This is useful in cases where a broadcaster already has an existing playout and/or graphics engine and only requires the viewer input to be processed and schedules created.

### 7. MULTIPLE STREAM EMBODIMENTS

Referring to FIGS. 16 to 19, as mentioned above in relation to several of the examples given in Section 6, embodiments of the present invention are not limited to dealing with single broadcast channels but can also be used to playout multiple interactive channels. Each of the multiple channels can be allocated to a different service or they can offer different parts of the same service. Each of the multiple channels can be broadcast to the same location, for aggregation and inclusion in another broadcast, or to different locations such as individual homes and/or pubs.

Further, the multiple channels can each:
be unique, having both different video/audio content and different viewer interactivity
share the same viewer interactivity but have different video/audio content, for example in the case of a community based service in which each community can choose different video/audio content but will see the same viewer interactivity,
share the same video/audio content but have different viewer interactivity per channel.

Each channel will effectively have its own dedicated RVIS 155 and the functionality 150 for user input sorting and data storage 155 provided in the network provider's domain 100 needs to adapted to sort user inputs by channel and to direct the user inputs to the correct RVIS 155. Such sorting can be provided in much the same way as described above for sorting user inputs by type. For example, different channels might be allocated different telephone numbers for users to call.

The components of the broadcast hosting domain 110 will generally be located differently when multiple channels are to be supported. They may all reside on the same physical machine or reside on two or more machines, depending on the desired implementation. For example, each channel will usually be provided with its own scheduler application 1200, clip table 1215 (which includes all available broadcast elements) and playout and graphics engine 1305 and these may be located together at the point of broadcast or “playout centre”. Other aspects of the broadcast hosting domain 110 however may be located remotely from the playout centre, at a facility shared amongst many channels. Embodiments of the present invention are flexible enough to support several different implementations for accommodating multiple channels.

Four examples of how parts of the broadcast hosting domain 110 may be located to broadcast multiple channels are described below. In each example it is assumed that there exists an RVIS 175 for each channel that is broadcast.

1) Multiple Channels with Local Deployment:

Referring to FIG. 16, in this deployment all components of the broadcast hosting domain 110 are located in the playout center for each channel. The whole broadcast hosting domain 110 is effectively reproduced for each different channel. This example is useful in cases where multiple versions of the same channel are required, each broadcast to a different geographic region. In this case the video/audio could be the same on each channel, but the viewer interaction will be region specific.

2) Multiple Channels with Hybrid Local/Remote Deployment:

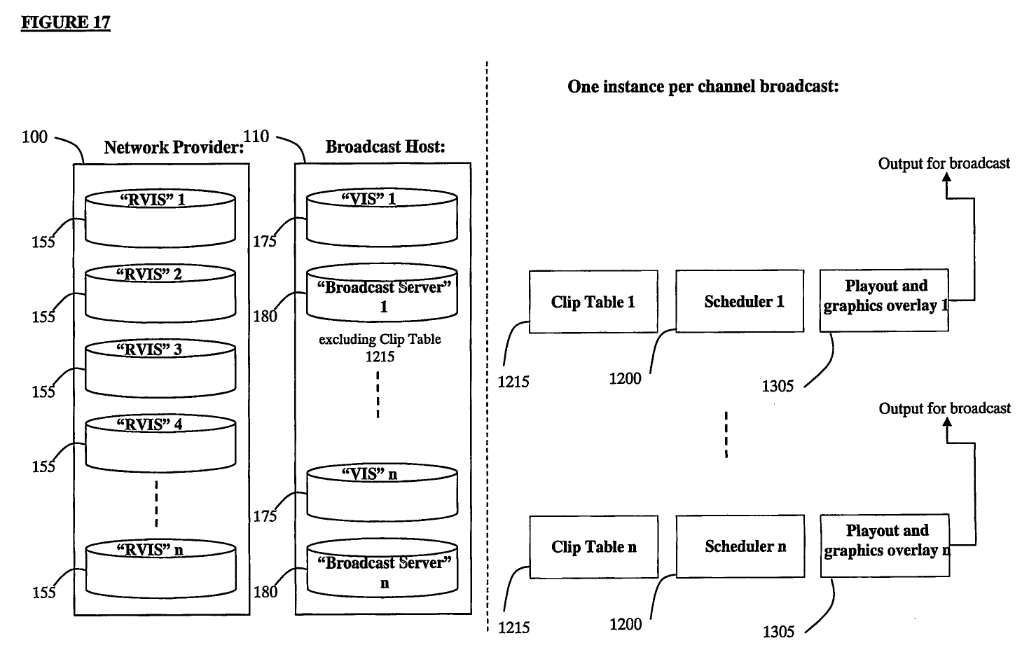

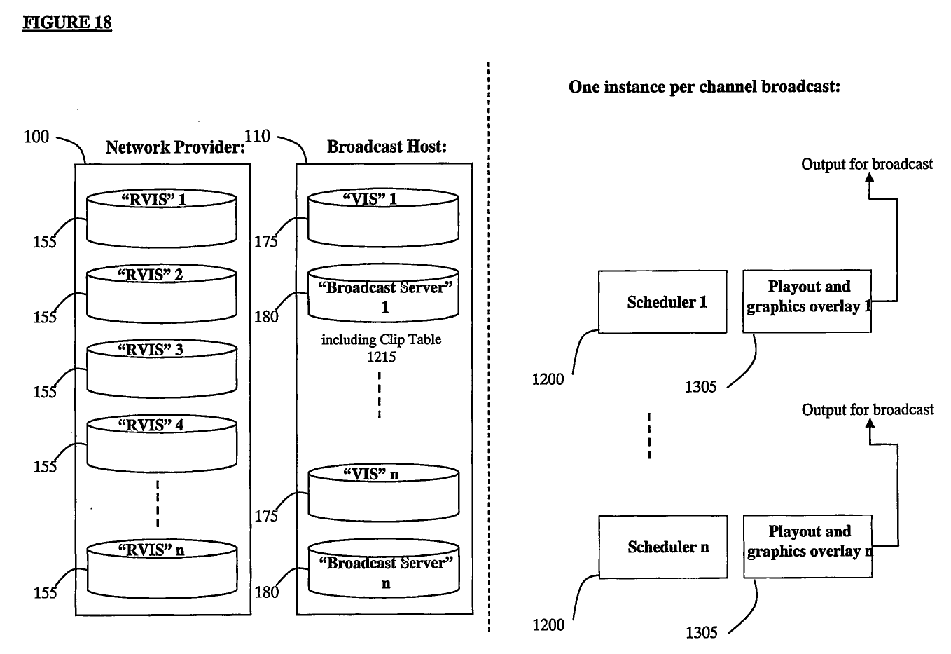

Referring to FIG. 17, in this example, the components of the broadcast hosting domain 110 are divided as follows: the scheduler application 1200, clip table 1215 (which includes all available broadcast elements) and playout and graphics engine 1305 reside in one location, for instance the playout centre, and the remaining components of the broadcast hosting domain 110 reside at a second location that may also house the RVIS 175. Thus, apart from the clip table 1215, the broadcast server database 1220 resides at the second location.

At the time of broadcast, the scheduler 1200 accesses the VIS database 1115 and broadcast server database 1220 via a secure communications link such as a DSL or t1 line. The scheduler 1200 decides what should be broadcast and the playout and graphics engine 1305 proceeds to playout the appropriate video, audio and graphics locally.

As seen in FIG. 17, the scheduler application 1200, clip table 1215 and playout and graphics engine 1305 must be replicated for each channel. This implementation is useful in a situation where each channel is received in a different physical location, such as a pub. In this case each pub may be voting for music or sports clips and send text messages for display on the screen. With this implementation each pub receives a dedicated channel that is specific to the patrons in it at that particular time—a community VOD service.

3) Multiple Channels with Remote to PC Deployment:

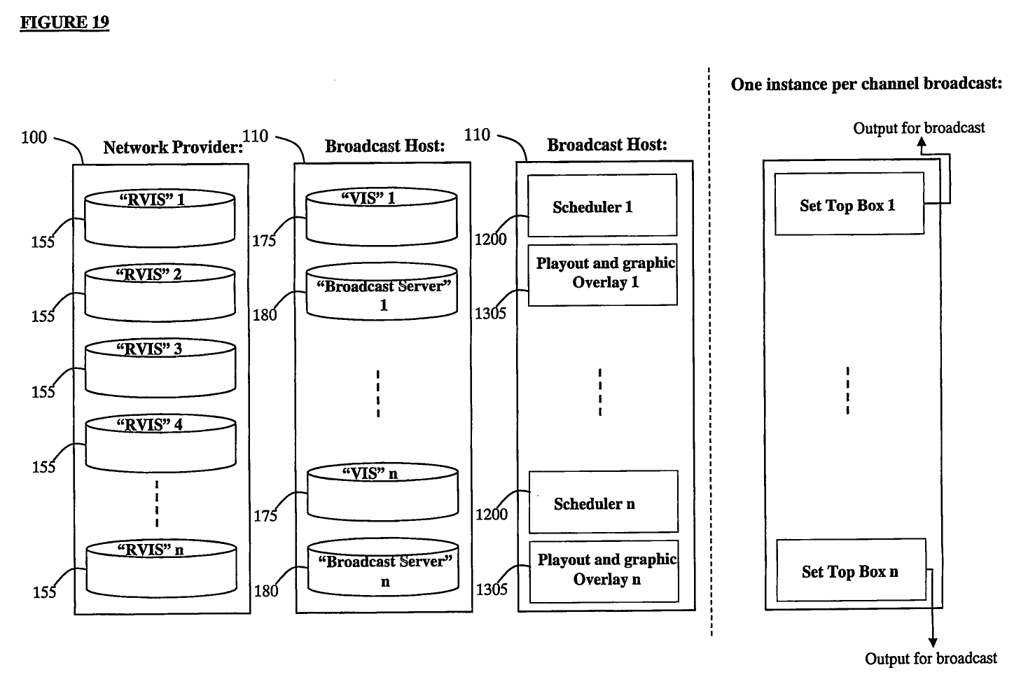

Referring to FIG. 18, in this example just the scheduler 1200 and playout and graphics engine 1305 are in the location from where a broadcast will be played out. The rest of the broadcast hosting domain 110 components are located in a different location. The scheduler 1200 accesses the VIS 175 and broadcast database 1220 for all required information remotely from the playout centre via a secure communication link. In this arrangement, just the scheduler 1200 and playout and graphics engine 1305 must be reproduced at the playout centre for each channel.

This implementation is useful in a business to business channel that needs to be seen in multiple locations. For example if an automobile dealership wanted to broadcast a channel to each of its locations, with the same video and viewer interaction so that viewers in different locations can exchange experiences and knowledge, then this implementation could be used.

4) Multiple Channels with Remote to STB Deployment:

Referring to FIG. 19, in this deployment all components of the broadcast hosting domain are located in the same location, and all channels are played out from that location. In the place where the channels are actually viewed, there is a set top box capable of receiving and outputting Windows Media, Real Media or other types of video/audio streams.

The playout and graphics engine 1305 component of the broadcast hosting domain 110 outputs multiple broadcast streams (as many as are required by the application) as Windows Media, Real Media or other type of video/audio stream. This is transmitted to the STBs via a standard IP connection. The STBs receive the video/audio stream and output the broadcast.

This implementation could be used for an interactive video on demand (VOD) service that is broadcast direct to viewers' homes. In this application multiple broadcast outputs are distributed via broadband connections to viewers' homes. Viewers each watch different video/audio (whichever programmes they selected) but they all see the same viewer interaction. So although they are watching different content, they are still interacting with each other via text or picture messages on the screen. Although each member of the community is watching something different, they are still behaving like a community.

It should be noted that, for the purposes of the present specification, the word “comprising” is intended to be interpreted, unless the context indicates otherwise, so as to include for instance at least the meaning of either of the following phrases: “consisting solely of” and “including amongst other things”.

It will be understood that embodiments of the present invention may be supported by platform of various types and configurations. The distribution of software and data storage across platform may be different from that described above. Further, the presence of the platform is not essential to an embodiment of the invention. An embodiment of the present invention might therefore comprise software recorded onto one or more data carriers, or embodied as a signal, for loading onto suitable platform for use.

1. A scheduling system for use in broadcasting comprising:
i) a scheduler for selecting and scheduling broadcast elements for broadcasting; and
ii) a user input data store for storing user input data
in which the scheduler is adapted to access the user input data store and to schedule broadcast elements, the scheduling of one or more broadcast elements being at least partially determined by stored user input data.

2. A scheduling system according to claim 1 wherein, in use, the user input data store stores one or more user inputs.

3. A scheduling system according to either one of the preceding claims wherein, in use, the user input data comprises data relating to user inputs.

4. A scheduling system according to any one of the preceding claims wherein, in use, stored user input data comprises one or more broadcast elements.

5. A scheduling system according to any one of the preceding claims wherein, in use, stored user input data identifies one or more broadcast elements.

6. A scheduling system according to claim 5 wherein at least one identified broadcast element comprises an item from a playlist.

7. A scheduling system according to either one of claims 5 or 6 wherein at least one identified broadcast element comprises material sourced externally to the broadcasting system.

8. A scheduling system according to claim 7 wherein at least one identified broadcast element comprises live material.

9. A scheduling system according to any one of the preceding claims which further comprises an asset store for storing broadcast elements to be scheduled by the scheduler.

10. A scheduling system according to claim 9 wherein the asset store is adapted to store data relating to the broadcast elements, in addition to storing broadcast elements.

11. A scheduling system according to any one of the preceding claims which further comprises a user input processor for processing user inputs.

12. A scheduling system according to claim 11 wherein, in use, at least one user input comprises a broadcast element and the user input processor comprises an editing tool for use in editing broadcast elements.

13. A scheduling system according either one of claims 11 or 12 wherein the user input processor is adapted to sort user input data according to type.

14. A scheduling system according to any one of claims 11, 12 or 13, for use in supporting more than one broadcast channel during the same broadcast period, wherein the user input processor is adapted to sort user input data according to channel.

15. A scheduling system according to any one of claims 11 to 14 wherein the user input processor is adapted to parse user input data.

16. A scheduling system according to any one of claims 11 to 15 wherein, in use, stored user input data identifies at least one broadcast element, and wherein the user input processor is adapted to measure a number of times said broadcast element is so identified.

17. A scheduling system according to claim 16 wherein the scheduler is adapted to rank broadcast elements in accordance with the number of times the elements are so identified.

18. A scheduling system according to any one of claims 11 to 17 wherein, in use, the user input processor is connected to deliver processed user inputs for storage in the user input data store for use by the scheduler in scheduling broadcast elements.

19. A scheduling system according to any one of claims 11 to 18 wherein the system is provided with a first output for scheduled broadcast elements for broadcasting and a second output for processed user inputs and/or broadcast elements.

20. A scheduling system according to any one of the preceding claims, further comprising time dependent control means to control the action of the scheduler according to time period.

21. A scheduling system according to claim 20 wherein the time period comprises part of a day, such that the action of the scheduler can be controlled to be different at different times of day.

22. A scheduling system according to claim 20 wherein the time period comprises one or more days, such that the action of the scheduler can be adjusted to be different on at least two different days.

23. A scheduling system according to any one of claims 20, 21 or 22 wherein the scheduler is adapted to select and schedule broadcast elements, and wherein the time dependent control means is adapted to control the selection of said one or more broadcast elements in a time dependent manner.

24. A scheduling system according to any one of claims 20 to 23 wherein the scheduler is adapted to schedule broadcast elements by applying at least one rule, and wherein the time dependent control means is adapted to control the rule or rules applied in a time dependent manner.

25. A scheduling system according to any one of the preceding claims adapted for connection to a communication system for receiving user inputs.

26. A scheduling system according to claim 25 having a response time of the order of ten minutes between receipt of a user input and delivery of a response which is at least partly dependent on the result of a scheduling operation by the scheduler in relation to the received user input.

27. A scheduling system according to claim 26 wherein said delivery of a response comprises broadcasting of a broadcast element.

28. A scheduling system according to claim 26 wherein said delivery of a response comprises the output of a communication in reply to the user input.

29. A broadcast assembly system for assembling broadcast elements for broadcast, the system comprising an asset store for storing one or more broadcast elements, and an asset processor for processing broadcast elements, wherein the asset store, in use, stores at least one rule or algorithm for use in assembling broadcast elements for broadcast and the asset processor provides at least one tool for processing broadcast elements by editing.

30. A broadcast assembly system according to claim 29, the system further comprising a scheduler for assembling broadcast elements by scheduling.

31. A broadcast assembly system according to either one of claims 29 or 30 wherein at least one stored rule or algorithm comprises a scheduling criterion for use in scheduling broadcast elements for broadcast.

32. A broadcast assembly system according to claim 31 wherein the scheduling criterion comprises a rule or algorithm for responding to at least one user input.

33. A broadcast assembly system according to either one of claims 31 or 32, wherein the asset processor comprises means to create or modify at least one scheduling criterion.

34. A broadcast assembly system according to any one of claims 32 to 33 wherein at least one stored rule or algorithm is time dependent.

35. A broadcast assembly system according to any one of claims 29 to 34, wherein the asset processor comprises means for creating or modifying one or more broadcast elements.

36. An interactive gaming system comprising a broadcast assembly system according to claim 35.

37. A broadcast assembly system according to any one of claims 32 to 36, further comprising a user input processor, and wherein the scheduling criterion comprises a rule or algorithm for responding to processed user inputs.

38. A broadcasting system comprising:
i) an asset store for storing broadcast elements;
ii) a user input data store for storing user input data;
iii) an asset processor for processing broadcast elements; and
iv) a user input processor for processing user inputs,
wherein the user input processor is adapted to process user input to provide user input data for storage in the user input data store and the asset processor is adapted to process broadcast elements for storage in the asset store.

39. A broadcasting system according to claim 38 wherein the asset processor comprises an encoder for encoding broadcast elements.

40. A broadcasting system according to either one of claims 38 or 39 wherein the asset processor comprises an editing tool for editing broadcast elements.

41. A broadcasting system according to any one of claims 38 to 40 wherein the asset processor comprises a programming tool for programming data and/or processes relating to broadcast elements.

42. A broadcasting system according to any one of claims 38 to 41 wherein the asset processor comprises a programming tool for programming scheduling criteria.

43. A broadcasting system according to any one of claims 38 to 42 wherein, in use, stored user input data comprises at least one broadcast element.

44. A broadcasting system according to any one of claims 38 to 43 arranged to provide more than one channel for broadcasting broadcast elements.

45. A broadcasting system according to claim 44 arranged such that two or more channels each carry a unique set of broadcast elements.

46. A broadcasting system according to claim 44 arranged such that two or more channels share at least one broadcast element from the asset store.

47. A broadcasting system according to claim 44 arranged such that two or more channels share at least one broadcast element from stored user input data.

48. A broadcasting system for supporting more than one independently interactive broadcasting channel.

49. A user input processor for use with a broadcasting system according to any one of claims 38 to 48, having an input for receiving user inputs, at least one processing tool for processing received user inputs, a first output for processed user inputs for use by the broadcasting system in scheduling broadcast elements and a second output for processed user inputs.

50. A user input processor according to claim 49 wherein the second output is adapted for connection to the Internet.

51. A user input processor according to either one of claims 49 or 50, for use in supporting more than one broadcast channel during the same broadcast period, wherein the user input processor is adapted to sort user inputs according to channel.

52. A method of broadcasting, said method comprising the steps of:
i) receiving a list of broadcast elements;
ii) receiving a user input relating to at least one broadcast element, and
iii) responding to the received user input.

53. A method according to claim 52 wherein a received user input comprises at least one broadcast element in addition to the listed broadcast elements.

54. A method according to either one of claims 52 or 53 wherein a received user input comprises at least one identifier for a broadcast element from the list.

55. A method according to either one of claims 53 or 54 wherein step iii) comprises broadcasting the additional broadcast element together with at least one broadcast element from the list.

56. A method according to any one of claims 52 to 55 wherein step iii) comprises outputting a reply to the user input.

57. A method according to claims 53 and 56 wherein said reply comprises an estimated broadcast time for the additional broadcast element.

58. A method according to any one of claims 52 to 57 wherein step iii) comprises re-ordering the list of broadcast elements.

59. A method according to any one of claims 52 to 58 wherein step iii) is performed in an hour or less of step ii).

60. A method according to any one of claims 52 to 59 wherein step iii) is performed in ten minutes or less after step ii).

61. A method according to any one of claims 52 to 59 wherein step iii) is performed in two minutes or less after step ii).

62. A method according to any one of claims 52 to 59 wherein step iii) is performed in ten seconds or less after step ii).

63. A method according to any one of claims 52 to 62, further comprising the steps of:
iv) receiving at least one user input identifying at least one of the broadcast elements on the list; and
v) generating a re-ordered list of programme broadcast from said list, in accordance with the at least one user input.

64. A method of assembling broadcast elements for broadcasting, said method comprising the steps of:
i) processing at least one broadcast element and loading the processed broadcast element to an asset store;
ii) receiving, via a user input, data relating to at least one broadcast element in the asset store; and
iii) storing one or more rules or algorithms for use in assembling a set of broadcast elements for broadcast in accordance with received data.

65. A method according to claim 64, further comprising the step of assembling a set of broadcast elements for broadcast in accordance with received data and at least one stored rule or algorithm.

66. A method according to either one of claims 64 or 65 wherein at least one stored rule or algorithm is time dependent such that an assembled set of broadcast elements is different at different times.

67. A method according to any one of claims 64 to 66, further comprising the step of receiving, via a user input, at least one broadcast element, and wherein an assembled set of broadcast elements comprises at least one broadcast element received via a user input.

68. A method according to any one of claims 64 to 67 which further comprises the step of broadcasting an assembled set.
